(19) United States
(12) Patent Application Publication
(10) Pub. No.: US 2021/0072033 A1
(43) Pub. Date: Mar. 11, 2021

(54) LOGISTICS AND TRANSPORTATION TECHNOLOGIES

(71) Applicant: SparkCognition, Inc., Austin, TX (US)

(72) Inventor: Syed Mohammad Amir Husain, Georgetown, TX (US)

(21) Appl. No.: 16/590,001

(22) Filed: Oct. 1, 2019

Related U.S. Application Data
(63) Continuation-in-part of application No. 16/515,543, filed on Jul. 18, 2019.
(60) Provisional application No. 62/745,072, filed on Oct. 12, 2018.
(60) Provisional application No. 62/702,232, filed on Jul. 23, 2018.

(51) Int. Cl. G01C 21/34; G06Q 10/02; G06Q 30/02; G06Q 50/30

(52) U.S. Cl. CPC G01C 21/3423; G01C 21/3438; G01C 21/3453; G06Q 2220/00; G06Q 30/0283; G06Q 50/30; G06Q 10/02

(57) ABSTRACT

Logistics and transportation technologies are disclosed. A globally unique identifier (GUID) of a user is used to access a rideshare router that determine which one or multiple modes of transport should be used for various segments of a planned journey. The modes can include both terrestrial and unmanned aerial options. The GUID of the user is used to post information to a distributed ledger, such as a blockchain or hyperledger. A smart key fob of a vehicle provides a user with access to mobility services and a full-on computer experience. Logistics and transportation data, including on-board diagnostics data, can be used to predict vehicle maintenance, calculate a vehicle health score, determine natural language generation of explanations regarding vehicle health, and even calculate a carbon footprint score.

### CROSS-REFERENCE TO RELATED APPLICATION

The present application claims priority from U.S. Provisional Application No. 62/745,072 filed Oct. 12, 2018, entitled “LOGISTICS AND TRANSPORTATION TECHNOLOGIES,” which is incorporated by reference herein in its entirety. The present application also claims priority to and is a continuation-in-part of U.S. patent application Ser. No. 16/515,543 filed Jul. 18, 2019, entitled “ARTIFICIAL INTELLIGENCE-BASED SYSTEMS AND METHODS FOR VEHICLE OPERATION,” which claims priority from U.S. Provisional Patent Application No. 62/702,232 filed Jul. 23, 2018, and entitled “ARTIFICIAL INTELLIGENCE-BASED SYSTEMS AND METHODS FOR VEHICLE OPERATION,” the contents of which are incorporated by reference herein in their entirety.

### BACKGROUND

Planes, trains, and automobiles are the primary forms of transport around the world, both for passengers as well as for cargo. Over the years, certain modes of transport have become the de facto standard for certain types of journeys. For example, in most cities, the mail is almost always delivered by a mail truck or car.

Highways are the original network; the Internet came later. Numerous technologies are available for use in trying to manage congestion and routing of packets across the Internet. Numerous technologies also exist to try to improve Internet safety via content filtering, malware detection, etc. In contrast, decades old problems that existed with roadways still exist today. For example, traffic jams, delayed arrivals, and road safety issues are still commonplace. Other than in-dash navigation, entertainment, and Bluetooth calling, consumer-facing technology in automobiles has changed slowly.

### BRIEF DESCRIPTION OF THE DRAWINGS

FIG. 1A illustrates a particular example of a system in accordance with the present disclosure;

FIG. 1B illustrates a particular example of logistics/transportation journey;

FIG. 1C illustrates a particular example of a system in accordance with the present disclosure;

FIG. 2 illustrates a particular example of a key device;

FIG. 3 illustrates particular examples of operation with respect to the key device of FIG. 2;

FIG. 4 illustrates a particular example of a system including autonomous agents, which in some examples can include vehicles operating in accordance with the present disclosure;

FIG. 5 illustrates a particular example of a system that is operable to support cooperative execution of a genetic algorithm and a backpropagation trainer for use in developing models to support logistics and transportation technologies;

FIG. 6 illustrates a particular example of a model developed by the system of FIG. 5;

FIG. 7 illustrates particular examples of first and second stages of operation at the system of FIG. 5;

FIG. 8 illustrates particular examples of third and fourth stages of operation at the system of FIG. 5;

FIG. 9 illustrates a particular example of a fifth stage of operation at the system of FIG. 5;

FIG. 10 illustrates a particular example of a sixth stage of operation at the system of FIG. 5;

FIG. 11 illustrates a particular example of a seventh stage of operation at the system of FIG. 5;

FIG. 12A illustrates a particular embodiment of a system that is operable to perform unsupervised model building for clustering and anomaly detection in connection with artificial intelligence-based vehicle operation;

FIG. 12B illustrates particular examples of data that may be received, transmitted, stored, and/or processed by the system of FIG. 12A;

FIG. 12C illustrates an example of operation at the system of FIG. 12A; and

FIG. 13 (is a diagram to illustrate a particular embodiment of neural networks that may be included in the system of FIG. 12A.

### DETAILED DESCRIPTION

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

Certain operations may be described herein as being performed by a network-accessible server. However, it is to be understood that such operations may be performed by multiple servers, such as in a cloud computing environment, or by node(s) a decentralized peer-to-peer system. Certain operations are also described herein as being performed herein by a computer in a vehicle. In alternative implementations, such operations may be performed by a different computer, such as a user's mobile phone or a key fob device.

The present application describes systems and methods that can intelligently, automatedly choose logistics and transport means without regard to any prevailing notion of what is the “proper” choice for a particular journey. As an illustrative example, a user may simply notify a mobile application (“app”) executing on the user's cell phone (or other mobile device) that the user wishes to travel (or that the user wants to send a package) to point B. The mobile app may determine that the person (or package) is currently at point A, e.g., based on GPS readings. The mobile app may send a message to a cloud computing service that is referred to herein as a “rideshare router.” The rideshare router can be communicably coupled to various logistics and transportation management platforms. To illustrate, the rideshare router may be configured to communicate with unmanned traffic management (UTM) systems, public transit systems (e.g., for trains, subways, buses, etc.), and terrestrial transport systems (e.g., car manufacturers, ride sharing services, autonomous vehicles, and car rental services).

Using artificial intelligence (AI) and machine learning (ML) models, the rideshare router may determine which mode(s) of transport is best suited for the user's (or the package's) journey from point A to point B. In some examples, the rideshare router may send messages to make reservations (e.g., for road/water/aerial transport) and/or conduct monetary transactions associated with the journey and sending messages to cause presentation of reservation confirmation and/or receipts to the user at their mobile devices. Such confirmations/receipts may include details regarding the reserved journey, user(s) that are scheduled to travel on the journey, etc. In particular aspects, the rideshare router may also utilize AI models to explain rationales behind its actions. To illustrate, the rideshare router may notify the user that an unmanned aerial vehicle (UAV) taxi was chosen for some or all of the journey due to terrestrial road traffic conditions between point A and point B. As another example, the rideshare router may notify the user that rideshare service #1 was used instead of rideshare service #2, or a departure time was adjusted, because rideshare service #2 was predicted to have an increase in dynamic pricing during the travel time period.

In the described logistics and transportation ecosystem, each user may have or be associated with a globally unique identifier (GUID) that is used to post transactions on a verified decentralized ledger, such as a public blockchain or a private hyperledger. UAV fleet operators, individual UAVs, cars, taxis, etc. may similarly be assigned or otherwise associated with GUIDs that are used to post information about them to the decentralized ledger. A user's GUID may also be used to access various perks and services, as further described herein.

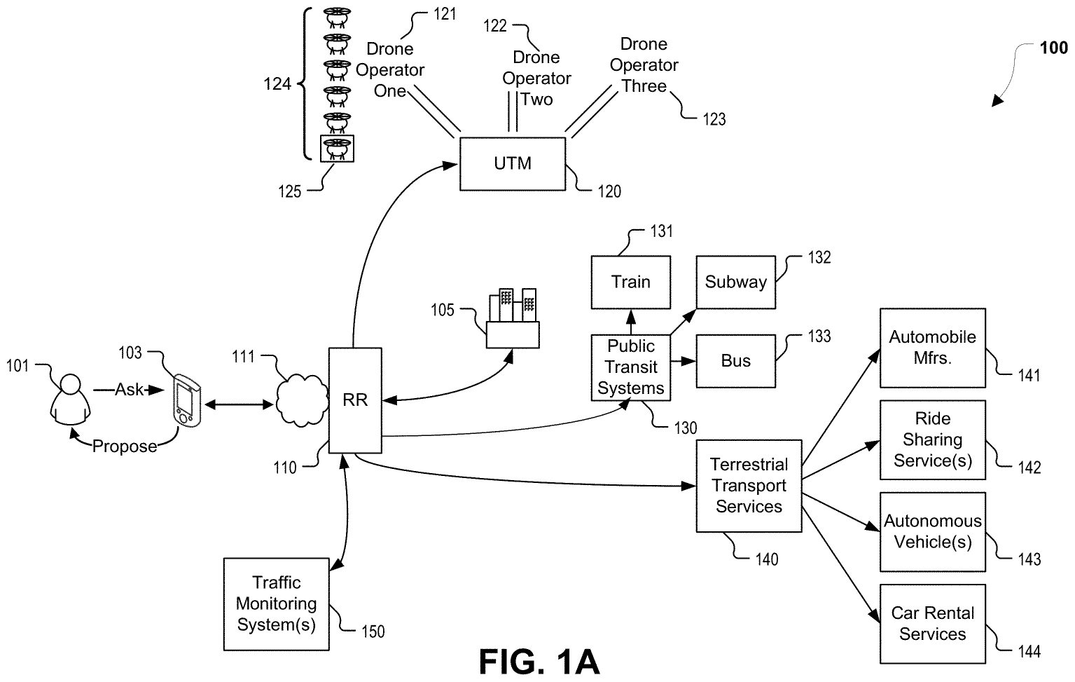

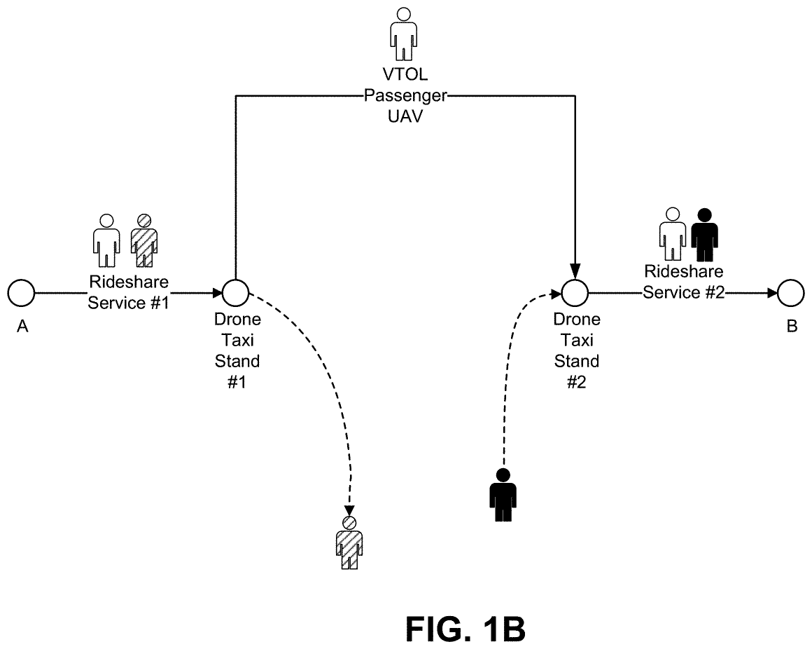

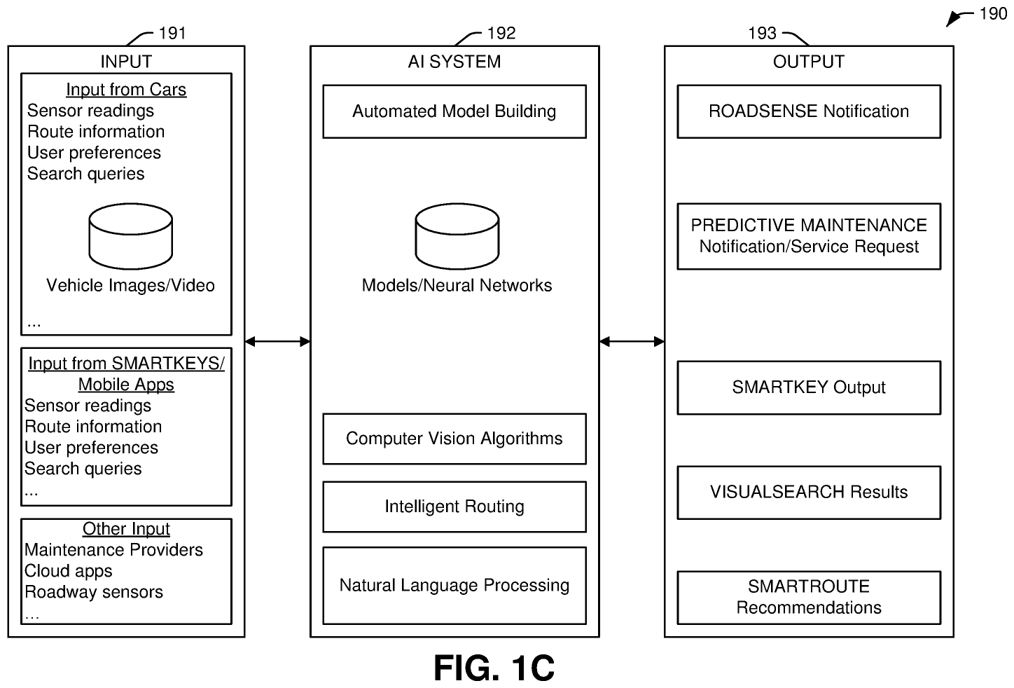

Referring to a FIG. 1A, a particular example of a system 100 in accordance with the present disclosure is shown. The system 100 includes a rideshare router 110, which in the illustrated example is a cloud service (e.g., executed at one or more computing device, such as servers) that is accessible via one or more networks 111, such as local area network(s), wide area network(s), the Internet, etc. The rideshare router 110 may be accessible by both individuals as well as corporate entities. In the example of FIG. 1A, the rideshare router 110 is accessible by a mobile device 103 of a user 101 and by an enterprise 105. In some examples, the rideshare router 110 corresponds to one or more server computers executing software operable to perform one or more operations described herein.

The rideshare router 110 is configured to communicate with a UTM 120, public transit systems 130, and terrestrial transport services 140. In some implementations, the rideshare router 110 can also communicate with one or more traffic monitoring systems 150. The UTM 120 is configured to communicate with a plurality of drone operators, such as illustrative drone operators 121, 122, 123. The drone operators may offer one or a fleet 124 of UAVs for use in fulfilling requests for package delivery or passenger transport. In the example of FIG. 1A, a particular UAV 125 is selected by the UTM 120. In various examples, the UTM 120 may provide one or more of the following services: aerial autonomy, predictive maintenance, airspace decongestion, route approval (including integration with authorities such as the Federal Aviation Administration (FAA)), and autonomous onboard cybersecurity for UAVs. Such functions may be supported by AI and machine learning. As an illustrative non-limiting example, a particular UAV may be predicted (e.g., by the UTM 120) to reach a failure state in the near future, and, as a response, maintenance operations may be scheduled (e.g., by the UTM 120 and/or based on message(s) transmitted from the UTM 120) on the particular UAV. As yet another example, the timing of vertical takeoff and landing (VTOL) events and flight routes may be dynamically adjusted based on blockchain-registered routes of other UAVs, updated weather information, regulatory events such as ground stops, etc.

The public transit systems 130 may include train systems 131, subway systems 132, and/or bus systems 133. The terrestrial transport services 140 may include automobile manufacturers 141, ridesharing services 142, autonomous vehicles 143, and car rental services 144.

The traffic monitoring system(s) 150 can include systems to sense, gather, or aggregate traffic information for various modes of travel, including modes of travel associated with each of the UTM 120, the public transit systems 130, and the terrestrial transport services 140. The traffic monitoring system(s) 150 can provide the rideshare router 110 with real-time traffic information for each of the modes of travel. In some implementations, the traffic monitoring system(s) 150 or the rideshare router 110 can also project future traffic conditions based on the real-time traffic information or other information. To illustrate, if a full train is about to arrive at a particular train station, the traffic monitoring system(s) 150 or the rideshare router 110 can use this information to estimate traffic congestion that will result from offloading passengers of the train. The rideshare router 110 uses the traffic information to select modes of travel for users. Additionally, in some implementations, the rideshare router 110 can send information about transportation arranged by the rideshare router 110 to the traffic monitoring system(s) 150 for use in estimating future traffic conditions. In some implementations, certain functions described as being performed by the traffic monitor system(s) may also, or instead, be performed by the rideshare router 110.

In a first example of operation, the enterprise 105 may request that a package be picked up from a designated pick up spot and delivered to a particular address. For example, a computing device at and/or associated with the enterprise 105 may send a message to the rideshare router 110, where the message includes information regarding the pick up spot, the delivery address, information about the package, etc. The rideshare router 110 may determine, in an example, that UAV package delivery should be used. To illustrate, in response to receiving the request message from the enterprise 105, the rideshare router 110 may identify available transportation options between the pick up and delivery addresses. The rideshare router 110 may also determine which of the available transportation options are appropriate in view of package information included in the request message. To illustrate, a rules engine at the rideshare router 110 may be executed, and may output an indication that certain types of goods should not be transported via terrestrial due to road conditions giving rise to spoilage/spill concerns. It is to be understood that the rideshare router 110 may determine that multiple types of transport are to be chained together to transport the package from the pick up spot to the destination.

In an example, the rideshare router 110 may send a request to the UTM 120, which may respond to the request by designating a particular UAV, such as the UAV 125, to perform the package pickup and delivery. The UTM 120 may also schedule the flight route of the UAV 125 and, in some cases, receive approval from an airspace authority. In one example, scheduling the flight route includes posting route information to the blockchain using one or more GUIDs (e.g., a GUID associated with the enterprise 105, a GUID associated with the assigned UAV 125, etc.). Data regarding successful or failed package delivery may also be posted (e.g., by the rideshare router 110, the first drone operator 121, the UAV 125, or a recipient of the package) to the blockchain.

In a second example of operation, the user 101 may ask (e.g., provide input to) a mobile app executing on the mobile device 103 to arrange for transportation from point A to point B. Alternatively, the mobile app executing on the mobile device 103 may propose transportation from point A to point B in response to predicting (e.g., based on previous journeys, a calendar, etc.) that the user is going to want to travel from point A to point B. A request including the user's GUID and information regarding the desired trip may be sent to the rideshare router 110, which may utilize one or more AI/machine learning models to determine what single or combination of transportation options should be used for the trip. In some examples, the rideshare router 110 communicates with the UTM 120, the public transit systems 130, and/or the terrestrial transport services 140 to determine real-time or near-real-time availability of various services. Such communication may occur using application programming interfaces (API) exposed by the various entities. API-based communication may also be used to make reservations and process payment for the trip, or segments thereof). If the user 101 has certain preferences, those preferences may be accessible (e.g., from a cloud server) based on the user's GUID, and may be applied by the rideshare router 110 and/or within the arranged-for airborne/terrestrial vehicles. To illustrate, the rideshare router 110 may optimize for cost, time of departure, time of arrival, physical limitations of the user, etc. based on such user preferences.

Thus, from the point of view of the user 101, the mobile app on the mobile device 103 is merely informed of desired departure and arrival locations/times and then proceeds to “make it happen.” Complex multi-passenger journeys may also be supported and may be scheduled in response to inputs from user(s) prior to the start of the journey. For example, FIG. 1B illustrates an example of such a journey, in which multiple users provide information regarding the desired journey (e.g., start time, start location, desired end time, desired end location, desired stops during the journey, whether specific users will be part of specific legs of the journey, etc.) to the rideshare router 110, which determines how to sequence portions of the overall journey. The rideshare router 110 may then send information to various parties (e.g., the users, transport services, UTM, etc.) to schedule the desired journey.

In the journey shown in FIG. 1B, a first user (unshaded) travels from point A to point B, but a second user (crosshatch shaded) is dropped off during after one segment of the journey and a third user (fully shaded) is picked up before another segment of the journey. To arrange for such a journey, the rideshare router 110 has, in the illustrated example, reserved dual-user terrestrial transportation from point A to a first drone taxi stand using a first rideshare service. At the first drone taxi stand, the first and second users (who each have their own GUIDs) separate. The first user continues from the first drone taxi stand to a second drone taxi stand by way of a VTOL passenger UAV reserved by the rideshare router 110. At the second drone taxi stand, the third user (having their own GUID) joins the first user and the two travel to point B using a second rideshare service. The rideshare router 110 may make payment for the various illustrated transports based on “wallet” information for one or more of the illustrated users, depending on whether each segment of the journey is to be paid for by one user or to be shared by all users traveling on that segment.

It will be appreciated that by quickly and efficiently routing packages or passengers across multiple modes of transport, the techniques of the present disclose may more efficiently use available travel space. For example, terrestrial traffic jams can be considerably alleviated if some of the packages and people in the cars of the traffic jams are instead routed in UAV taxis for at least part of their journey based on real-time data available to the rideshare router 110.

It is to be understood the various examples of operation described herein are provided for illustrative purposes only, and are not to be considered limiting. Numerous other examples of operation may be supported by the techniques described in this disclosure.

Each user in the logistics/transportation system of the present disclosure may be associated with a GUID. GUIDs may uniquely identify a passenger/traveler, a package, etc. The GUID may be communicated to a car, aircraft, etc. via near-field communication (NFC), telecommunications, plugging in of a device (e.g., a smart key fob, as further described herein) into a universal serial bus (USB) port, etc. The GUID may be used to integrate travel identification across different modes of travel. The GUID may also be used to post information regarding a journey to a distributed ledger, such as a blockchain or hyperledger. In a first example, all of the posted information is public. In a second example, posted metadata is public but block payloads are encrypted. In a third example, all posted information is private, such as when a private hyperledger is used.

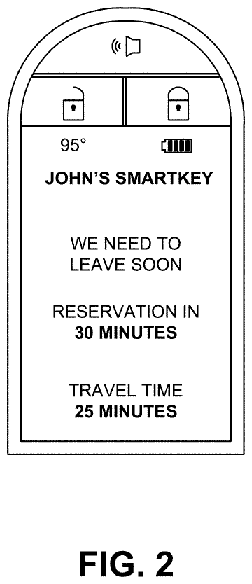

In accordance with a particular aspect, cars (e.g., such as those made by the automobile manufacturer 141) may come with one or more smart key fobs, an example of which is shown in FIG. 2. The smart key fob may be a small (e.g., wireless car remote key sized) device that provides mobile computer functionality, mobility services, and even docking functionality. To illustrate, the smart key fob may include a high-definition multimedia interface (HDMI) to deliver media services. The smart key fob may also include physical/hardware buttons, such as lock, unlock, trunk open/close, panic, etc. In some examples, the smart key fob includes a USB port for charging/communication and a display screen. In some examples, the same port may be used for both media output as well as for charging. The smart key fob, which may alternatively be referred to herein as a “smart key,” may replace the conventional key for an automobile and may be a blockchain-enabled ID that unlocks access to AI services and serves as a natural language capable AI avatar in a key fob and a secure, digital identity to access user preferences. In some examples, operations described herein as being performed by a mobile device or a user device may be performed by a smart key fob. To illustrate, the smart key fob may include a processor and a memory storing processor-executable instructions to control network communications, execute trained models, generate notifications, etc.

In particular examples, the smart key fob enables a user to maintain constant connectivity with digital services. An always-available AI system within the smart key fob may support any-time voice conversation with the smart key fob. The integrated display (which may be e-paper, a color LCD touchscreen, etc.) provides notifications and prompts.

The smart key fob can also unlock additional benefits, including, but not limited to, integration with “pervasive preferences.” For example, as soon as the person in possession of a particular smart key fob enters a vehicle and/or uses their smart key fob to activate the vehicle, various vehicle persona preferences may be fetched from a network server (or from a memory of the smart key fob itself) and may be applied to the vehicle. It is to be understood that such preferences need not be vehicle-specific. Rather, the preferences may be applied whether the car is owned by the user, a rental car, or even if the user is a passenger and the driver of the car allows the preference to be applied (e.g., the user is in the back seat of a vehicle while using a ride-hailing service and the user's preferred radio station is tuned in response to the user's smart key fob). Moreover, such pervasive preferences, which are linked to the user's GUID, may persist across different forms of transportation (e.g., a purchased car, a rented car, a train, a bus, an autonomous vehicle, a UAV passenger transport, etc.). Illustrative, non-limiting examples of “pervasive preferences” that can be triggered by a smart key fob include automatic seat adjustment, steering settings, climate control settings, mirror and camera settings, lighting settings, entertainment settings (including downloading particular apps, music, podcasts, etc.), and vehicle performance profiles. In various examples, the display of the smart key fob may show weather information, battery status, messages received from a vehicle, a network server, or another user, calendar information, estimated travel time, etc.

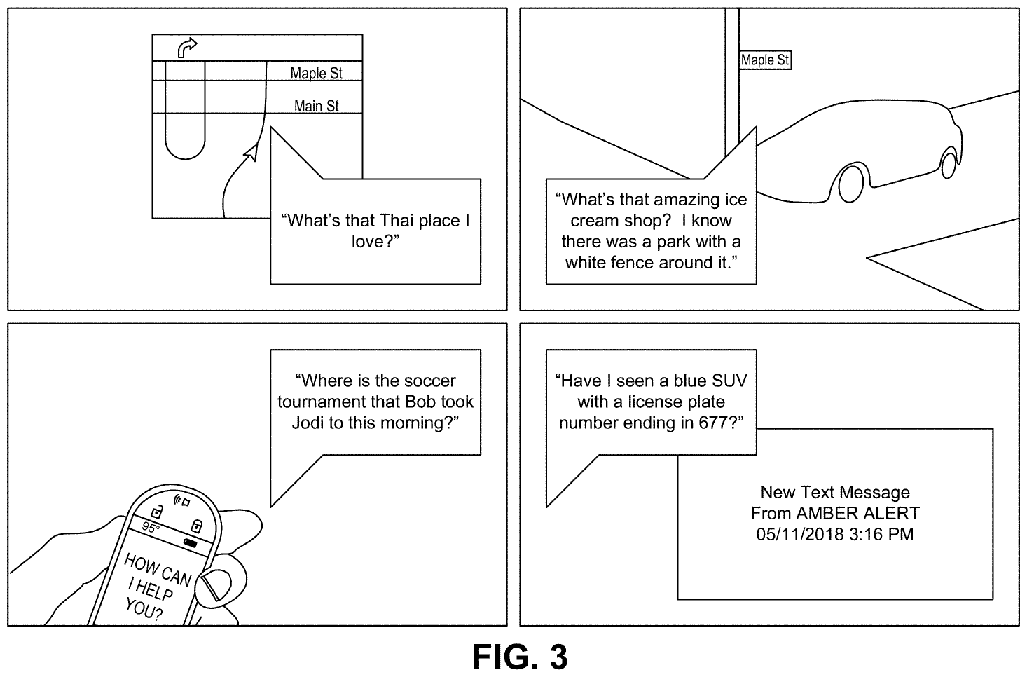

In accordance various aspects, a smart key may be (or may include) an embedded, wireless computer that enables a user to maintain constant connectivity with digital services. An always-available AI system within the smart key supports any-time voice conversation with the smart key. An integrated e-paper display provides notifications and prompts from the cognitive platform. The smart key may also be used to access/interact with other systems described herein. A particular illustrative example of a smart key is shown in FIG. 3, though it is to be understood that in alternative implementations a smart key may have another form factor and/or appearance.

In some examples, the system 100 supports predictive maintenance operations based on AI-driven analysis of on-board diagnostic (OBD) data produced by a vehicle. As an illustrative non-limiting example, the system 100 may determine, based on a combination of sensors/metrics (e.g., temperature, vibration, fluid viscosity, fuel efficiency, tire pressure, etc.) that a specific engine problem (e.g., oil pump failure, spark knock, coolant leakage, radiator clog, spark plug wear, loosening gas cap, etc.) is ongoing or will occur sometime in the future.

In one aspect, OBD data may be streamed to a smart key fob, the mobile app on the mobile device 103, or a server. At the smart key fob, mobile app, or server, a cognitive prognostics model may be executed, where the model is specific to the particular vehicle that produced the OBD data. The model may predict future maintenance issues. Responsive to prediction of an issue, predictive maintenance operations may be scheduled and/or automatically performed if an actuatable device (e.g., a maintenance robot) is available. Maintenance predictions can be messaged back to the vehicle, the smart key fob, the mobile app, etc. Moreover, aggregate analyses may also be performed in the system 100 based on OBD data. To illustrate, if the same type of problem is being predicted in multiple cars having the same make/model, varied cars in the same geographical area, etc., a recall event may be predicted. In response, early remedial measures can be investigated and eventually recommended/performed.

OBD data may also be used to calculate a “health score” for a vehicle. The health score may be published to vehicle pricing guides and websites, to dealerships, to retailers, to internet shopping websites, etc. Unlike existing vehicle history services, the described health score is based on OBD data from the vehicle itself and may therefore be more accurate and representative of a current state of the vehicle. In some examples, data regarding individual vehicles or regarding multiple vehicles can be sold back to third-parties, such as retailers, as an embeddable micro service. Such data may also be of interest to insurance companies, for example to determine which customers or prospective customers to offer discounts to. It is noted that the vehicle health score need not just be a numeric score. In some examples, a natural language generation (NLG) model may receive the health score and/or OBD data as input, and may output a natural language explanation of the status of the vehicle, may provide advice, etc.

In accordance with the described techniques, a terrestrial or airborne vehicle provides the appearance of a near-perfect photographic memory. As examples, a user can ask a vehicle to remind them where exactly they saw that wonderful gelateria with the beautiful red door, whether there was a package by the front door that they forgot to notice as they were driving to work in the morning, etc. Notably, if a vehicle is being asked the question, that vehicle need not be the same vehicle (or even the same type of vehicle) that the user was in when they saw the gelateria or left the house in the morning. With the visual search system, vehicles are capable of seeing, perceiving and remembering, as well as responding to questions expressed in natural language. Moreover, because the user's GUID drives the transport experience, information from multiple vehicles that the user has previously traveled in may be aggregated to be searched. The visual search system may be accessed from a smart key fob, a mobile phone app, and/or within a vehicle itself.

In some examples, the visual search system stores images/videos captured by some or all cameras of vehicles, such as UAVs, cars, buses, trains, etc. Such data may be stored at the vehicles, at network-accessible storage, or a combination thereof. The images/videos may be stored in compressed fashion or computer vision features extracted by feature extraction algorithms may be stored rather than storing the raw images/video. Artificial intelligence algorithms, such as object detection, object recognition, etc., may operate on the stored data based on input from a natural language processing system and potentially in conjunction with other systems.

For example, in the “gelateria with the beautiful red door” example described above, the natural language processing system may determine that the user is looking for a dessert shop that the user passed by while in UAV or terrestrial transport, where the dessert shop (or a shop near it) had a door that was painted red (or a color close to red) and may have had decoration on the door. Using this input, the visual search system may conduct a search of aggregated historical camera data from vehicles that the user has traveled in, GPS/trip information regarding previous travel by the user (whether in that same vehicle or in a different vehicle while the user had his/her smart key fob), and navigation places-of-interest information to find candidates of the dessert shop in question. A list of the search results can be displayed to the user via the smart key fob, the mobile app, or on a display screen in the vehicle the user is in. Search results that serve gelato or have red doors may be elevated in the list of search results, and a photo of such a red door may be displayed, if available.

A more targeted search can be conducted for the “did I fail to notice a package this morning” example. In this example, the visual search system may determine which camera(s) were pointed at the door/yard of the user's home when the user's car was parked overnight, and may scan through the images/video from such cameras to determine if a package was present or a delivery was made during the timeframe in question. Other automatic/manually-initiated searches are also possible using the visual search system: “What's that Thai place I love?”, “Where's that ice cream shop? I know there was a park with a white fence around it.”, “Where is the soccer tournament James took Tommy to this morning?” (where James and Tommy are family members and at least one of them have their own smart key fob or other GPS-enabled device), “Have I seen a blue SUV with a license plate number ending in 677?” The last of these may even be performed automatically in response to an Amber/Silver/Gold/Blue Alert. Some examples of search queries, including visual search queries, are shown in FIG. 3.

In aspects, the cameras and object detection/recognition subsystems of a vehicle may be always-on. When a pothole, speed trap, lane obstruction, pileup, etc. is detected, an event may be communicated to a service. In one example, the service is owned and operated by a vehicle manufacturer. Alternatively or in addition, the service is one that supports user-annotations of traffic and road conditions, such as Waze.

Using OBD data, a carbon footprint score may be computed for a user (e.g., for a particular GUID). The user's driving style, acceleration/braking habits, fuel economy, frequency and duration of travel, etc. may impact the carbon footprint score. Use of electrical vehicles may be ignored or may be weighted differently than use of vehicles that consume fossil fuels. Information regarding carbon footprint scores of users may be of interest to certain companies (e.g., to incentivize lower carbon footprint users) and/or to governments/municipalities, (e.g., so that cities can trade individual carbon footprints in a marketplace). Carbon footprint scores may also be used as a factor in determining progressive taxation brackets. In a particular aspect, an environmentally conscious user having a low carbon footprint score may sell “carbon credits” to third-parties that have higher carbon footprint scores of their own. It is noted that the described carbon footprint score may be specific to logistics/transport, and therefore may not be impacted, for example, by the fact that user has and uses a coal-burning ovens at home.

In various aspects, AI/machine learning components may be leveraged in the system 100 of FIG. 1A. Examples of such components are further described herein. To illustrate, selected embodiments below describe automated generation of models based on neuroevolution and automated generation of models based on a variational autoencoder, and such models may be used, for example, to predict future maintenance needs of a vehicle. Further, selected embodiments below describe use of neural networks or other machine learning to generate likely scenarios that can be used in decision making. In addition, selected embodiments below describe communication between autonomous agents using blockchain.

In an aspect, a smart route system in accordance with the present disclosure may utilize predictive algorithms that monitor expected arrival times reported by various vehicles/user devices. The smart route system may also utilize an AI-powered reservation system that supports “booking” of roadway (e.g., highway) capacity by piloted and autonomous vehicles. For example, various vehicles that will be traveling on a commonly-used roadway may “book” the roadway. “Booking” a roadway may simply mean notifying a network server of the intended route/time of travel, or may actually involve receiving confirmation of booking, from a network server associated with a transit/toll authority, to travel on the road. The confirmation of booking may identify a particular time or time period that the vehicle has booked. Such “bookings” may be incentivized, for example by lower toll fees or by virtue of fines, tolls, or higher tolls being levied against un-booked vehicles.

The smart route system may be simple to use. A user may start by associating an account with their smart key. Next, the user may specify their home, office, and other frequent destinations. AI can do the rest. As the user begins to drive their vehicle, the smart route system detects common trips and schedules. Using the smart key (or a mobile app), the smart route system may prompt the user whether they would like to make advance reservations for roadways and provide information on a successful booking (e.g., time that the reservation was made) via the smart key (or the mobile app). The smart route system may integrate with the user's calendar to propose advance route reservations for any identified destination.

To illustrate, as more and more vehicles include the smart route system and more and more users use their smart route system, more accurate predictions regarding current route delays can be made and more advance knowledge of the origins and destinations of vehicles is available. The smart route system may use this data to project future roadway capacity constraints. In some examples, the smart route system may re-route a vehicle, notify a driver of departure time changes, and list optional travel windows with expected arrival times based on intended routes of other vehicles, the user's calendar, current location of the vehicle, a destination of the vehicle, or a combination thereof.

In some cases, the smart route system rewards responsible drivers who follow recommended instructions/road reservations. The smart route system may also recommend a driving speed, because in some cases reducing your speed may actually help a user reach their destination faster. Similarly, the smart route system may notify the user that they are better off leaving earlier or later than planned in view of expected traffic. If a user has a flexible schedule, the smart route system may incentivize delayed departures and give route priority to drivers that are on a tighter schedule.

FIG. 1C illustrates a particular example of a logical diagram of a system 190 in accordance with the present disclosure. Various components shown in FIG. 1C may be placed within one or more vehicles or may be network-accessible. For example, certain components of FIG. 1 may be at a first computer within an automobile, a key device (e.g., a smart key) and/or a second computer (such as a network server) that is accessible to the first computer and to the key device via one or more networks.

FIG. 1 includes an “Input” category 191 and an “Output” category 193. Between the Input and Output categories 191, 193 is a logical tier 192 called “AI System”, components of which may be present at vehicles, at smart key, at mobile apps, at network servers, at peer-to-peer nodes, in other computer systems, or any combination thereof. The various entities shown in FIG. 1C may be communicatively coupled via wire or wirelessly. In some examples, communication occurs via one or more wired or wireless networks, including but not limited to local area networks, wide area networks, private networks, public networks, and/or the internet.

In FIG. 1C, the input category 191 includes input from vehicles, input from smart keys and mobile apps, and other input. Input from cars and input from smart key/mobile apps can include sensor readings, route information, user preferences, search queries, etc. Input from cars may further include vehicle images/video and/or features extracted therefrom. Other input may include input from maintenance service providers, cloud applications, roadway sensors, etc.

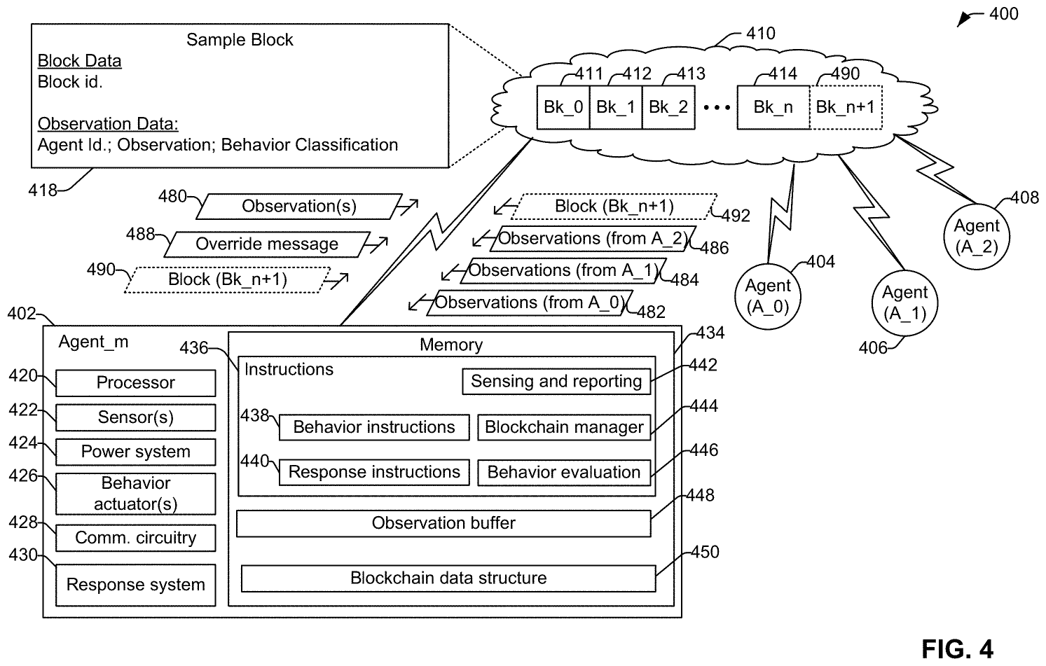

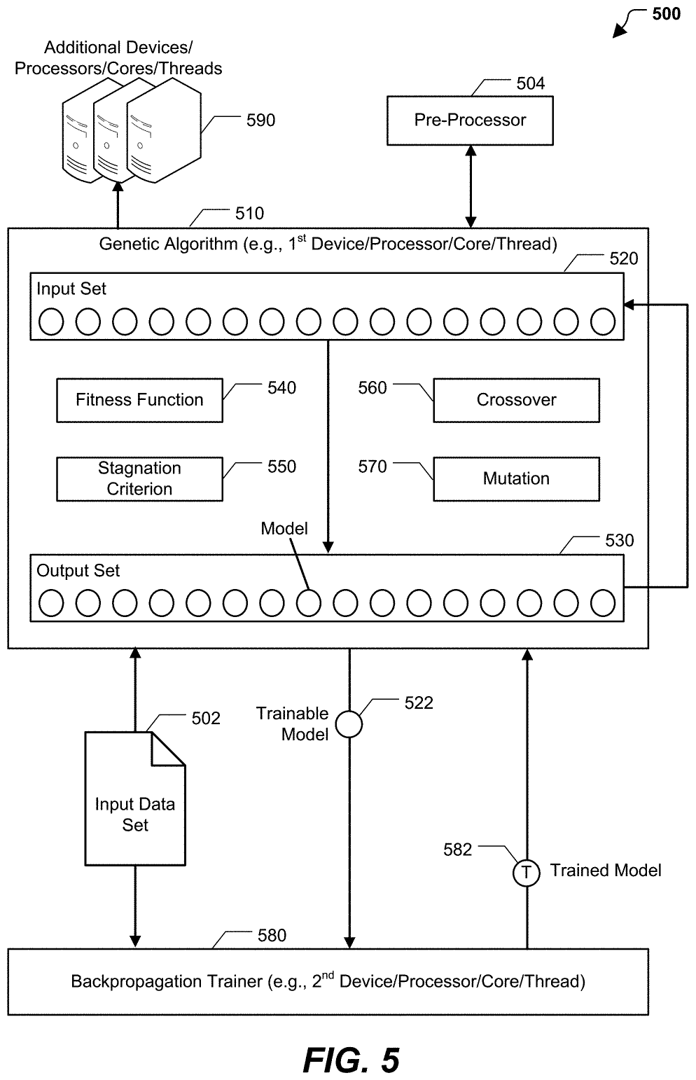

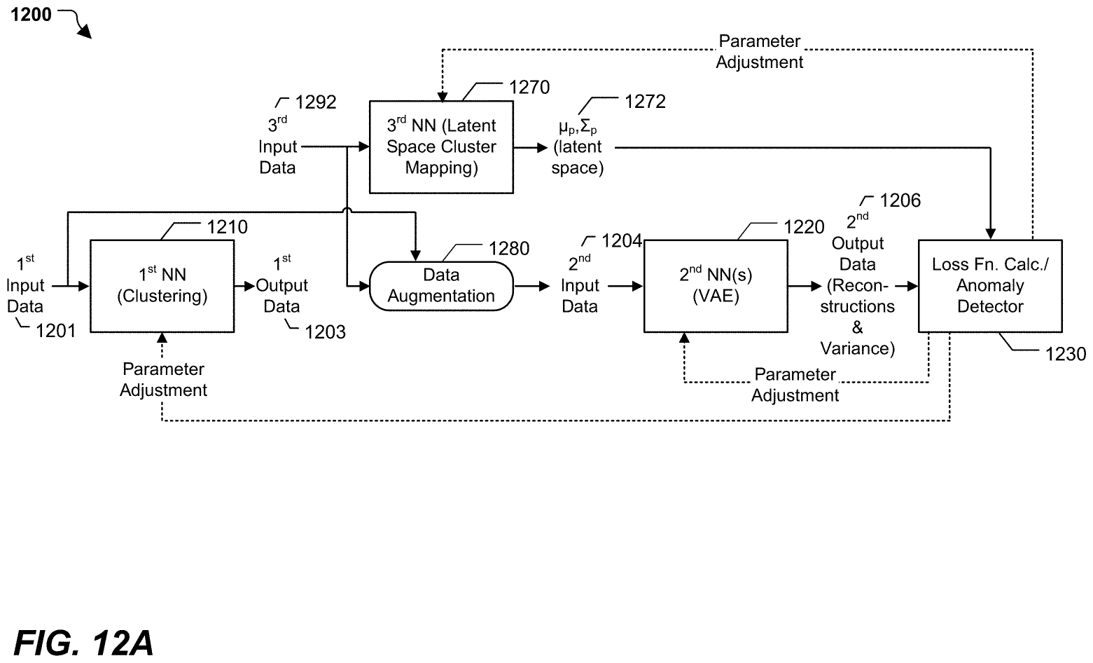

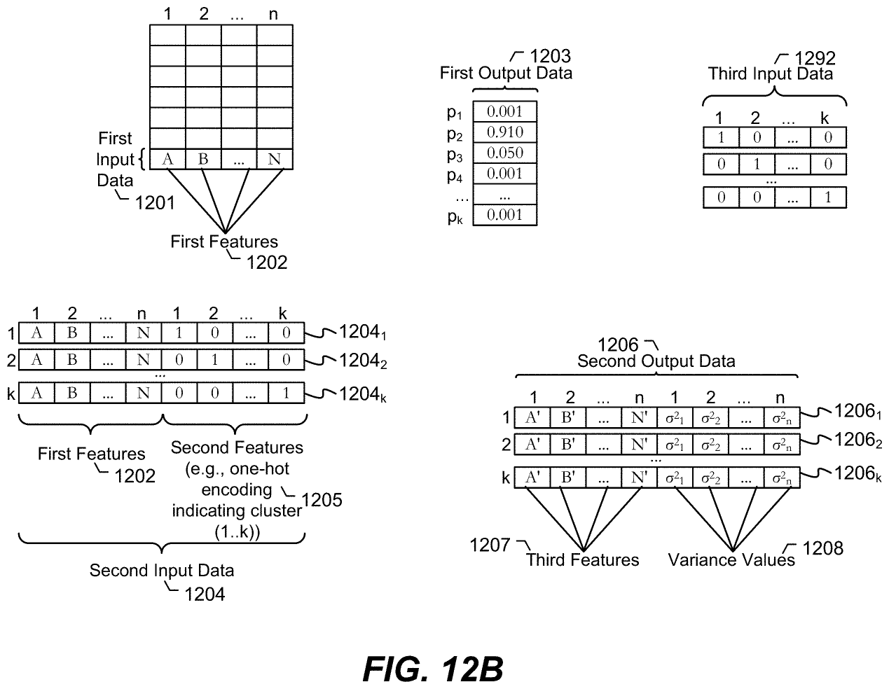

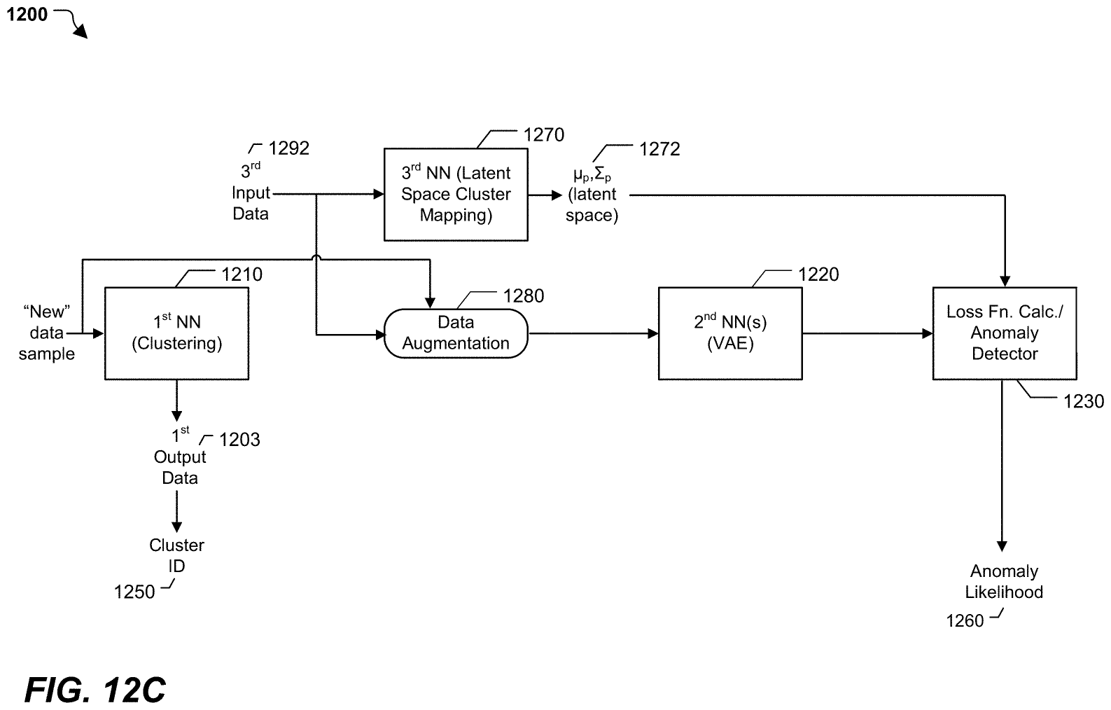

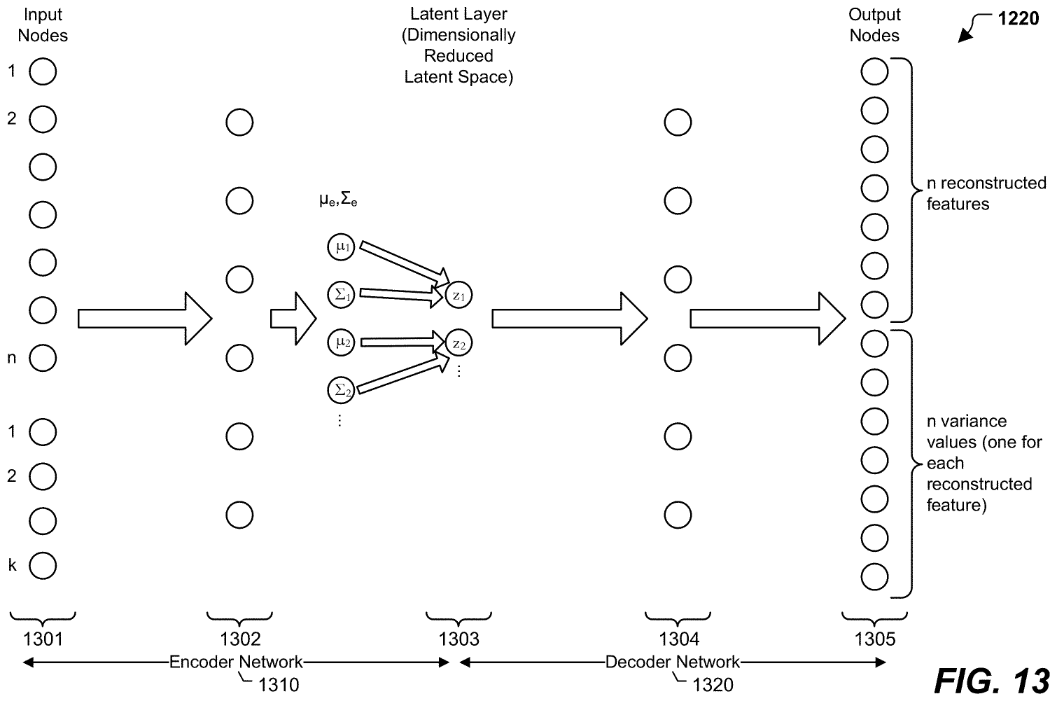

The AI system tier 192 includes automated model building, models (some of which may be artificial neural networks), computer vision algorithms, intelligent routing algorithms, and natural language processing engines. Examples of such AI system components are further described with reference to FIGS. 4-13. To illustrate, FIGS. 5-11 describe automated generation of models based on neuroevolutionary techniques, and FIGS. 12-13 describe automated generation of models using unsupervised learning techniques and a variational autoencoder.

The output category 193 includes road sense notifications, predictive maintenance notifications, smart key output, visual search results, and smart route recommendations. It is to be understood that in alternative implementations, the input category 191, the AI system tier 192, and/or the output category 193 may have different components than those shown in FIG. 1C.

In some examples, the described techniques may enable a vehicle to operate as an autonomous agent device. Unless otherwise clear from the context, the term “autonomous agent device” refers to both fully autonomous devices and semi-autonomous devices while such semi-autonomous devices are operating independently. A fully autonomous device is a device that operates as an independent agent, e.g., without external supervision or control. A semi-autonomous device is a device that operates at least part of the time as an independent agent, e.g., autonomously within some prescribed limits or autonomously but with supervision. An example of a semi-autonomous agent device is a self-driving vehicle in which a human driver is present to supervise operation of the vehicle and can take over control of the vehicle if desired. In this example, the self-driving vehicle may operate autonomously after the human driver initiates a self-driving system and may continue to operate autonomously until the human driver takes over control. As a contrast to this example, an example of a fully autonomous agent device is a fully self-driving car in which no driver is present (although passengers may be).

In some examples, such as for the predictive maintenance system, a public, tamper-evident ledger may be used. The public, tamper-evident ledger includes a blockchain of a shared blockchain data structure, instances of which may be stored in local memories of vehicles and/or at network servers.

FIG. 4 illustrates a particular example of a system 400 including a plurality of agent devices 402-408. One or more of the agent devices 402-408 is an autonomous agent device. Unless otherwise clear from the context, the term “autonomous agent device” refers to both fully autonomous devices and semi-autonomous devices while such semi-autonomous devices are operating independently. A fully autonomous device is a device that operates as an independent agent, e.g., without external supervision or control. A semi-autonomous device is a device that operates at least part of the time as an independent agent, e.g., autonomously within some prescribed limits or autonomously but with supervision. An example of a semi-autonomous agent device is a self-driving vehicle in which a human driver is present to supervise operation of the vehicle and can take over control of the vehicle if desired. In this example, the self-driving vehicle may operate autonomously after the human driver initiates a self-driving system and may continue to operate autonomously until the human driver takes over control. As a contrast to this example, an example of a fully autonomous agent device is a fully self-driving car in which no driver is present (although passengers may be). For ease of reference, the terms “agent” and “agent device” are used herein as synonyms for the term “autonomous agent device” unless it is otherwise clear from the context.

As described further below, the agent devices 402-408 of FIG. 4 include hardware and software (e.g., instructions) to enable the agent devices 402-408 to communicate using distributed processing and a public, tamper-evident ledger. The public, tamper-evident ledger includes a blockchain of a shared blockchain data structure 410, instances of which are stored in local memory of each of the agent devices 402-408. For example, the agent device 402 includes the blockchain data structure 450, which is an instance of the shared blockchain data structure 410 stored in a memory 434 of the agent device 402. The blockchain is used by each of the agent devices 402-408 to monitor behavior of the other agent devices 402-408 and, in some cases, to potentially respond to behavior deviations among the other agent devices 402-408, as described further below. The blockchain may also be used to collect other data regarding operation of vehicles, as further described herein. As used herein, “the blockchain” refers to either to the shared blockchain data structure or to an instance of the shared blockchain data structure stored in a local memory, such as the blockchain data structure 450.

Although FIG. 4 illustrates four agent devices 402-408, the system 400 may include more than four agent devices or fewer than four agent devices. Further, the number and makeup of the agent devices may change from time to time. For example, a particular agent device (e.g., the agent device 406) may join the system 400 after the other agent device 402, 404, 408 have noticed (or begun monitoring) one another. To illustrate, after the agent devices 402, 404, 408 have formed a group, the agent device 406 may be added to the group, e.g., in response to the agent device 406 being placed in an autonomous mode after having operated in a controlled mode or after being tasked to autonomously perform an action. When joining a group, the agent device 406 may exchange public keys with other members of the group using a secure key exchange process. Likewise, a particular agent device (e.g., the agent device 408) may leave the group of the system 400. To illustrate, the agent device 408 may leave the group when the agent device leaves an autonomous mode in response to a user input. In this illustrative example, the agent device 408 may rejoin the group or may join another group upon returning to the autonomous mode.

In some implementations, the agent devices 402-408 include diverse types of devices. For example, the agent device 402 may differ in type and functionality (e.g., expected behavior) from the agent device 408. To illustrate, the agent device 402 may include an autonomous aircraft, and the agent device 408 may include an infrastructure device at an airport. Likewise, the other agent devices 404, 406 may be of the same type as one another or may be of different types. While only the features of the agent device 402 are shown in detail in FIG. 4, one or more of the other agent devices 404-408 may include the same features, or at least a subset of the features, described with reference to the agent device 402. For example, as described further below, the agent device 402 generally includes sub-systems to enable communication with other agent devices and sub-systems to enable the agent device 402 to perform desired behaviors (e.g., operations that are the main purpose or activity of the agent device 402). In some cases, sub-systems for performing self-policing and sub-systems to enable a self-policing group to override the agent device 402 may also be included. The other agent devices 404-408 also include these sub-systems, except that in some implementations, a trusted infrastructure agent device may not include a sub-system to enable the self-policing group to override the trusted infrastructure agent device.

In FIG. 4, the agent device 402 includes a processor 420 coupled to communication circuitry 428, the memory 434, one or more sensors 422, one or more behavior actuators 426, and a power system 424. The communication circuitry 428 includes a transmitter and a receiver or a combination thereof (e.g., a transceiver). In a particular implementation, the communication circuitry 428 (or the processor 420) is configured to encrypt an outgoing message using a private key associated with the agent device 402 and to decrypt an incoming message using a public key of an agent device that sent the incoming message. Thus, in this implementation, communications between the agent devices 402-408 are secure and trustworthy (e.g., authenticated).

The sensors 422 can include a wide variety of types of sensors configured to sense an environment around the agent device 402. The sensors 422 can include active sensors that transmit a signal (e.g., an optical, acoustic, or electromagnetic signal) and generate sensed data based on a return signal, passive sensors that generate sensed data based on signals from other devices (e.g., other agent devices, etc.) or based on environmental changes, or a combination thereof. Generally, the sensors 422 can include any combination of or set of sensors that enable the agent device 402 to perform its core functionality and that further enable the agent device 402 to detect the presence of other agent devices 404-408 in proximity to the agent device 402. In some implementations, the sensors 422 further enable the agent device 402 to determine an action that is being performed by an agent device that is detected in proximity to the agent device 402. In this implementation, the specific type or types of the sensors 422 can be selected based on actions that are to be detected. For example, if the agent device 402 is to determine whether one of the other agent devices 404-408 is driving erratically, the agent device 402 may include an acoustic sensor that is capable of isolating sounds associated with erratic driving (e.g., tire squeals, engine noise variations, etc.). Alternatively, or in addition, the agent device 402 may include an optical sensor that is capable of detecting erratic movement of a vehicle.

The behavior actuators 426 include any combination of actuators (and associated linkages, joints, etc.) that enable the agent device 402 to perform its core functions. The behavior actuators 426 can include one or more electrical actuators, one or more magnetic actuators, one or more hydraulic actuators, one or more pneumatic actuators, one or more other actuators, or a combination thereof. The specific arrangement and type of behavior actuators 426 depends on the core functionality of the agent device 402. For example, if the agent device 402 is an automobile, the behavior actuators 426 may include one or more steering actuators, one or more acceleration actuators, one or more braking actuators, etc. In another example, if the agent device 402 is a household cleaning robot, the behavior actuators 426 may include one or more movement actuators, one or more cleaning actuators, etc. Thus, the complexity and types of the behavioral actuators 426 can vary greatly from agent device to agent device depending on the purpose or core functions of each agent device.

The processor 420 is configured to execute instructions 436 from the memory 434 to perform various operations. For example, the instructions 436 include behavior instructions 438 which include programming or code that enables the agent device 402 to perform processing associated with one or more useful functions of the agent device 402. To illustrate, the behavior instructions 438 may include artificial intelligence instructions that enable the agent device 402 to autonomously (or semi-autonomously) determine a set of actions to perform. The behavior instructions 438 are executed by the processor 420 to perform core functionality of the agent device 402 (e.g., to perform the main task or tasks for which the agent device 402 was designed or programmed). As a specific example, if the agent device 402 is a self-driving vehicle, the behavior instructions 438 include instructions for controlling the vehicle's speed, steering the vehicle, processing sensor data to identify hazards, avoiding hazards, and so forth.

The instructions 436 also include blockchain manager instructions 444. The blockchain manager instructions 444 are configured to generate and maintain the blockchain. As explained above, the blockchain data structure 450 is an instance of, or an instance of at least a portion of, the shared blockchain data structure 410. The shared blockchain data structure 410 is shared in a distributed manner across a plurality of the agent devices 402-408 or across all of the agent devices 402-408. In a particular implementation, each of the agent devices 402-408 stores an instance of the shared blockchain data structure 410 in local memory of the respective agent device. In other implementations, each of the agent devices 402-408 stores a portion of the shared blockchain data structure 410 and each portion is replicated across multiple of the agent devices 402-408 in a manner that maintains security of the shared blockchain data structure 410 public (i.e., available to other agent devices) and incorruptible (or tamper evident) ledger.

The shared blockchain data structure 410 stores, among other things, data determined based on observation reports from the agent devices 402-408. An observation report for a particular time period includes data descriptive of a sensed environment around one of the agent devices 402-408 during the particular time period. To illustrate, when a first agent device senses the presences of or actions of a second agent device, the first agent device may generate an observation include data reporting the location and/or actions of the second agent and may include the observation (possibly with one or more other observations) in an observation report. Each agent device 402-408 sends its observation reports to the other agent devices 402-408. For example, the agent device 402 may broadcast an observation report 480 to the other agent device 404-408. In another example, the agent device 402 may transmit an observation report 480 to another agent device (e.g., the agent device 404) and the other agent device may forward the observation report 480 using a message forwarding functionality or a mesh networking communication functionality. Likewise, the other agent devices 404-408 transmit observation reports 482-486 that are received by the agent device 402. In some examples when the distributed agents include vehicles, observation reports may include information regarding conditions (e.g., travel speed, traffic conditions, weather conditions, potholes, etc.) detected by the vehicles, trip/booking information, etc.

The observation reports 480-486 are used to generate blocks of the shared blockchain data structure 410. For example, FIG. 4 illustrates a sample block 418 of the shared blockchain data structure 410. The sample block 418 illustrated in FIG. 4 includes a block data and observation data.

The block data of each block includes information that identifies the block (e.g., a block id.) and enables the agent devices 402-408 to confirm the integrity of the blockchain of the shared blockchain data structure 410. For example, the block id. of the sample block 418 may include or correspond to a result of a hash function (e.g., a SHA256 hash function, a RIPEMD hash function, etc.) based on the observation data in the sample block 418 and based on a block id. from the prior block of the blockchain. For example, in FIG. 4, the shared blockchain data structure 410 includes an initial block (Bk_0) 411, and several subsequent blocks, including a block Bk_1 412, a block Bk_2 413, and a block Bk_n 414. The initial block Bk_0 411 includes an initial set of observation data and a hash value based on the initial set of observation data. The block Bk_1 412 includes observation data based on observation reports for a first time period that is subsequent to a time when the initial observation data were generated. The block Bk_1 412 also includes a hash value based on the observation data of the block Bk_1 412 and the hash value from the initial block Bk_0 411. Similarly, the block Bk_2 413 includes observation data based on observation reports for a second time period that is subsequent to the first time period and includes a hash value based on the observation data of the block Bk_2 413 and the hash value from the block Bk_1 412. The block Bk_n 414 includes observation data based on observation reports for a later time period that is subsequent to the second time period and includes a hash value based on the observation data of the block Bk_n 414 and the hash value from the immediately prior block (e.g., a block Bk_n−1). This chained arrangement of hash values enables each block to be validated with respect to the entire blockchain; thus, tampering with or modifying values in any block of the blockchain is evident by calculating and verifying the hash value of the final block in the block chain. Accordingly, the blockchain acts as a tamper-evident public ledger of observation data from members of the group.

Each of the observation reports 480-486 may include a self-reported location and/or action of the agent device that send the observation report, a sensed location and/or action of another agent device, sensed locations and/or observations or several other agent devices, other information regarding “smart” vehicle functions described with reference to FIGS. 1-3, or a combination thereof. For example, the processor 420 of the agent device 402 may execute sensing and reporting instructions 442, which cause the agent device 402 sense its environment using the sensors 422. While sensing, the agent device 402 may detect the location of a nearby agent device, such as the agent device 404. At the end of the particular time period or based on detecting the agent device 404, the agent device 402 generates the observation report 480 reporting the detection of the agent device 404. In this example, the observation report 480 may include self-reporting information, such as information to indicate where the agent device 402 was during the particular time period and what the agent device 402 was doing. Additionally, or in the alternative, the observation report 480 may indicate where the agent device 404 was detected and what the agent device 404 was doing. In this example, the agent device 402 transmits the observation report 480 and the other agent devices 404-408 send their respective observation reports 482-486, and data from the observations reports 480-486 is stored in observation buffers (e.g., the observation buffer 448) of each agent device 402-408.

In some implementations, the blockchain manager instructions 442 are configured to determine whether an observation in the observation buffer 448 is confirmed by one or more other observations. For example, after the observation report 482 is received from the agent device 404, data from the observation report 482 (e.g., one or more observations) are stored in the observation buffer 448. Subsequently, the sensors 422 of the agent device 402 may generate sensed data that confirms the data. Alternatively, or in addition, another of the agent devices 406-408 may send an observation report 484, 486 that confirms the data. In this example, the blockchain manager instructions 442 may indicate that the data from the observation report 482 stored in the observation buffer 448 is confirmed. For example, the blockchain manager instructions 442 may mark or tag the data as confirmed (e.g., using a confirmed bit, a pointer, or a counter indicating a number of confirmations). As another example, the blockchain manager instructions 442 may move the data to a location of the memory 434 of the observation buffer 448 that is associated with confirmed observations. In some implementations, data that is not confirmed is eventually removed from the observation buffer 448. For example, each observation or each observation report 480-486 may be associated with a time stamp, and the blockchain manager instructions 442 may remove an observation from the observation buffer 448 if the observation is not confirmed within a particular time period following the time stamp. As another example, the blockchain manager instructions 442 may remove an observation from the observation buffer 448 if at least one block that includes observations within a time period correspond to the time stamp has been added to the blockchain.

The blockchain manager instructions 442 are also configured to determine when a block forming trigger satisfies a block forming condition. The block forming trigger may include or correspond to a count of observations in the observation buffer 448, a count of confirmed observations in the observation buffer 448, a count of observation reports received since the last block was added to the blockchain, a time interval since the last block was added to the blockchain, another criterion, or a combination thereof. If the block forming trigger corresponds to a count (e.g., of observations, of confirmed observations, or of observation reports), the block forming condition corresponds to a threshold value for the count, which may be based on a number of agent devices in the group. For example, the threshold value may correspond to a simple majority of the agent devices in the group or to a specified fraction of the agent devices in the group.

In a particular implementation, when the block forming condition is satisfied, the blockchain manager instructions 444 form a block using confirmed data from the observation buffer 448. The blockchain manager instructions 444 then cause the block to be transmitted to the other agent devices, e.g., as block Bk_n+1 490 in FIG. 4. Since each of the agent devices 402-408 attempts to form a block when its respective block forming condition is satisfied, and since the block forming conditions may be satisfied at different times, block conflicts can arise. A block conflict refers to a circumstance in which a first agent (e.g., the agent device 402) forms and sends a first block (e.g., the Bk_n+1 490), and simultaneously or nearly simultaneously, a second agent device (e.g., the agent device 404) forms and sends a second block (e.g., a block Bk_n+1 492) that is different than the first block. In this circumstance, some agent devices receive the first block before the second block while other agent devices receive the second block before the first block. In this circumstance, the blockchain manager instructions 444 may provisionally add both the first block and the second block to the blockchain, causing the blockchain to branch. The branching is resolved when the next block is added to the end of one of the branches such that one branch is longer than the other (or others). In this circumstance, the longest branch is designated as the main branch. When the longest branch is selected, any observations that are in block corresponding to a shorter branch and that are not accounted for in the longest branch are returned to the observation buffer 448.

The memory 434 also includes behavior evaluation instructions 446, which are executable by the processor 420 to determine a behavior of another agent and to determine whether the behavior conforms to a behavior criterion associated with the other agent device. The behavior can be determined based on observation data from the blockchain, from confirmed observations in the observation buffer 448, or a combination thereof. Some behaviors may be determined based on a single confirmed observation. For example, if a device is observed swerving to avoid an obstacle on the road and the observation is confirmed, the confirmed observation corresponds to the behavior “avoiding obstacle”. Other behaviors may be determined based on two or more confirmed observations. For example, a first confirmed observation may indicate that the agent device is at a first location at a first time, and a second confirmed observation may indicate that the agent device is at a second location at a second time. These two confirmed observations can be used to determine a behavior indicating an average direction (i.e., from the first location toward the second location) and an average speed of movement of the agent device (based on the first time, the second time, and a distance between the first location and the second location). Such information may be utilized by the road sense system and/or the smart route system described with reference to FIGS. 1-3.

The particular behavior or set of behaviors determined for each agent device may depend on behavior criteria associated with each agent device. For example, if behavior criteria associated with the agent device 404 specify a boundary beyond which the agent device 404 is not allowed to carry passengers, the behavior evaluation instructions 446 may evaluate each confirmed observation of the agent device 404 to determine whether the agent device 404 is performing a behavior corresponding to carrying passengers, and a location of the agent device 404 for each observation in which the agent device 404 is carrying passengers. In another example, a behavior criterion associated with the agent device 406 may specify that the agent device 406 should always move at a speed less than a speed limit value. In this example, the behavior evaluation instructions 446 do not determine whether the agent device 406 is performing the behavior corresponding to carrying passengers; however, the behavior evaluation instructions 446 may determine a behavior corresponding to an average speed of movement of the agent device 406. The behavior criteria for any particular agent device 402-408 may identify behaviors that are required (e.g., always stop at stop signs), behaviors that are prohibited (e.g., never exceed a speed limit), behaviors that are conditionally required (e.g., maintain an altitude of greater than 4000 meters while operating within 2 kilometers of a naval vessel), behaviors that are conditionally prohibited (e.g., never arm weapons while operating within 2 kilometers of a naval vessel), or a combination thereof. Based on the confirmed observations, each agent device 402-408 determines corresponding behavior of each other agent device based on the behavior criteria for the other agent device.

After determining a behavior for a particular agent device, the behavior evaluation instructions 446 compare the behavior to the corresponding behavior criterion to determine whether the particular agent device is conforming to the behavior criterion. In some implementations, the behavior criterion is satisfied if the behavior is allowed (e.g., is whitelisted), required, or conditionally required and the condition is satisfied. In other implementations, the behavior criterion is satisfied if the behavior is not disallowed (e.g., is not blacklisted), is not prohibited, is not conditionally prohibited and the condition is satisfied, or is conditionally prohibited but the condition is not satisfied. In yet other examples, criteria representing events of interest (e.g., avoiding road obstacles, slowing down due to traffic congestion, exiting to a roadway that is not listed in a previously filed (e.g., in the blockchain) travel plan, etc. may be established and checked.

In some implementations, the behavior criteria for each of the agent devices 402-408 are stored in the shared blockchain data structure 410. In other implementations, the behavior criteria for each of the agent devices 402-408 are stored in the memory of each agent devices 402-408. In other implementations, the behavior criteria are accessed from a trusted public source, such as a trusted repository, based on the identity or type of agent device associated with the behavior criteria. In yet another implementation, an agent device may transmit data indicating behavior criteria for the agent device to other agent devices of the group when the agent device joins the group. In this implementation, the data may include or be accompanied by information that enables the other agent devices to confirm the authenticity of the behavior criteria. For example, the data (or the behavior criteria) may be encrypted by a trusted source (e.g., using a private key of the trusted source) before being stored on the agent device. To illustrate, when the agent device 402 receives data indicating behavior criteria for the agent device 406, the agent device 402 can confirm that the behavior criteria came from the trusted source by decrypting the data using a public key associated with the trusted source. Thus, the agent device 406 is not able to transmit fake behavior criteria to avoid appropriate scrutiny of its behavior.

In some implementations, if a first agent device determines that a second agent device is violating a criterion for expected behavior associated with the second agent device, the first agent device may execute response instructions 440. The response instructions 440 are executable to initiate and perform a response action. For example, each agent device 402-408 may include a response system, such as a response system 430 of the agent device 402. Depending on implementation and the nature of the agent devices, the response system 430 may initiate various actions.

In the case of autonomous military aircraft, the actions may be configured to stop the second agent device or to limit effects of the second agent device's non-conforming behavior. For example, the first agent device may attempt to secure, constrain, or confine the second agent device. To illustrate, such actions may include causing the agent device 402 to move toward the agent device 404 to block a path of the agent device 404, using a restraint mechanism (e.g., a tether) that the agent device 402 can attach to the agent device 404 to stop or limit the non-conforming behavior of the agent device 404, etc.

In the case of autonomous road vehicles (e.g., passenger cars, trucks, and SUVs), the response actions may include communicating and/or using observations regarding other agents. For example, if a first vehicle observes a second vehicle in a neighboring lane swerve to avoid a road obstacle, both the first vehicle and the second vehicle may provide corresponding observations and data (e.g., sensor readings, camera photos of the obstacle, etc.) to the road sense system, which may in turn respond to the verified observation of the road obstacle by pushing an alert to other vehicles that will encounter the obstacle. When confirmed observation(s) are received that the obstacle has been cleared, the road sense system may clear the notification.

It will be appreciated that one or more trained models may be used in various examples of the present disclosure. For example, training data for a first trained model may include day and time information, weather conditions, travel durations, etc. as determined based on input from various public and/or private sources. Once trained, the first trained model may be used by the rideshare router 110 to determine how to schedule a requested journey (or package transport) the first model may output indications of what modes of transport are preferable, which of multiple alternative “paths” (e.g., roadways, waterways, UAV sectors, etc.) are acceptable for various legs of the journey, whether it would be preferable to start the journey later, etc. In such examples, information into the first trained model may include information input by user(s), information determined from public/private sources, information as measured by particular sensors, information posted to a blockchain, etc.

As another example, training data for a second trained model may include maintenance records for particular types of vehicles. Information regarding a particular vehicle (e.g., as measured by sensors, determined from blockchain posts, etc.) may be input into the second trained model, which may out likelihoods of maintenance events occurring in the future. When a likelihood of a maintenance event exceeds a threshold, a predictive maintenance operation may be scheduled.

As yet another example, models may be trained based at least in part on vehicle health scores and/or carbon footprint scores. For example, a combination of such score data and maintenance data may be used to train a model that outputs information regarding “risk” associated with the vehicle, which may be used to determine an insurance premium for the vehicle, a price for the vehicle, etc.

Referring to FIG. 5, a particular illustrative example of a system 500 operable to train models is shown. The system 500, or portions thereof, may be implemented using (e.g., executed by) one or more computing devices, such as laptop computers, desktop computers, mobile devices, servers, and Internet of Things devices and other devices utilizing embedded processors and firmware or operating systems, etc. In the illustrated example, the system 500 includes a genetic algorithm 510 and a backpropagation trainer 580. The backpropagation trainer 580 is an example of an optimization trainer, and other examples of optimization trainers that may be used in conjunction with the described techniques include, but are not limited to, a derivative free optimizer (DFO), an extreme learning machine (ELM), etc. The combination of the genetic algorithm 510 and an optimization trainer, such as the backpropagation trainer 580, may be referred to herein as an “automated model building (AMB) engine.” In some examples, the AMB engine may include or execute the genetic algorithm 510 but not the backpropagation trainer 580, for example as further described below for reinforcement learning problems.

In particular aspects, the genetic algorithm 510 is executed on a different device, processor (e.g., central processor unit (CPU), graphics processing unit (GPU) or other type of processor), processor core, and/or thread (e.g., hardware or software thread) than the backpropagation trainer 580. The genetic algorithm 510 and the backpropagation trainer 580 may cooperate to automatically generate a neural network model of a particular data set, such as an illustrative input data set 502. In particular aspects, the system 500 includes a pre-processor 504 that is communicatively coupled to the genetic algorithm 510. Although FIG. 5 illustrates the pre-processor 504 as being external to the genetic algorithm 510, it is to be understood that in some examples the pre-processor may be executed on the same device, processor, core, and/or thread as the genetic algorithm 510. Moreover, although referred to herein as an “input” data set 502, the input data set 502 may not be the same as “raw” data sources provided to the pre-processor 504. Rather, as further described herein, the pre-processor 504 may perform various rule-based operations on such “raw” data sources to determine the input data set 502 that is operated on by the automated model building engine. For example, such rule-based operations may scale, clean, and modify the “raw” data so that the input data set 502 is compatible with and/or provides computational benefits (e.g., increased model generation speed, reduced model generation memory footprint, etc.) as compared to the “raw” data sources.

As further described herein, the system 500 may provide an automated data-driven model building process that enables even inexperienced users to quickly and easily build highly accurate models based on a specified data set. Additionally, the system 500 simplify the neural network model to avoid overfitting and to reduce computing resources required to run the model.

The genetic algorithm 510 includes or is otherwise associated with a fitness function 540, a stagnation criterion 550, a crossover operation 560, and a mutation operation 570. As described above, the genetic algorithm 510 may represent a recursive search process. Consequently, each iteration of the search process (also called an epoch or generation of the genetic algorithm) may have an input set (or population) 520 and an output set (or population) 530. The input set 520 of an initial epoch of the genetic algorithm 510 may be randomly or pseudo-randomly generated. After that, the output set 530 of one epoch may be the input set 520 of the next (non-initial) epoch, as further described herein.

The input set 520 and the output set 530 may each include a plurality of models, where each model includes data representative of a neural network. For example, each model may specify a neural network by at least a neural network topology, a series of activation functions, and connection weights. The topology of a neural network may include a configuration of nodes of the neural network and connections between such nodes. The models may also be specified to include other parameters, including but not limited to bias values/functions and aggregation functions.

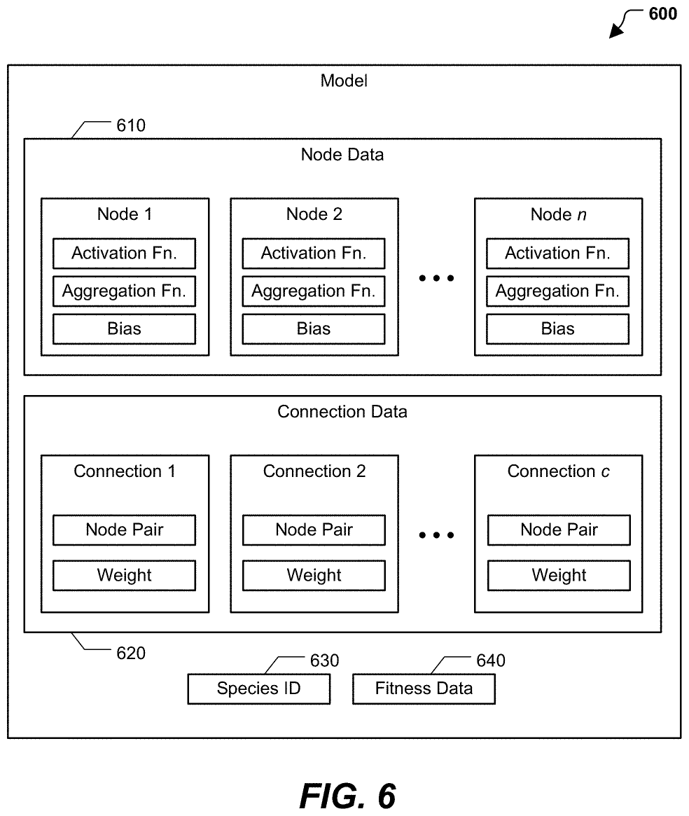

Additional examples of neural network models are further described with reference to FIG. 6. In particular, as shown in FIG. 6, a model 600 may be a data structure that includes node data 610 and connection data 620. In the illustrated example, the node data 610 for each node of a neural network may include at least one of an activation function, an aggregation function, or a bias (e.g., a constant bias value or a bias function). The activation function of a node may be a step function, sine function, continuous or piecewise linear function, sigmoid function, hyperbolic tangent function, or other type of mathematical function that represents a threshold at which the node is activated. The biological analog to activation of a node is the firing of a neuron. The aggregation function may be a mathematical function that combines (e.g., sum, product, etc.) input signals to the node. An output of the aggregation function may be used as input to the activation function. The bias may be a constant value or function that is used by the aggregation function and/or the activation function to make the node more or less likely to be activated.

The connection data 620 for each connection in a neural network may include at least one of a node pair or a connection weight. For example, if a neural network includes a connection from node N1 to node N2, then the connection data 620 for that connection may include the node pair <N1, N2>. The connection weight may be a numerical quantity that influences if and/or how the output of N1 is modified before being input at N2. In the example of a recurrent network, a node may have a connection to itself (e.g., the connection data 620 may include the node pair <N1, N1>).

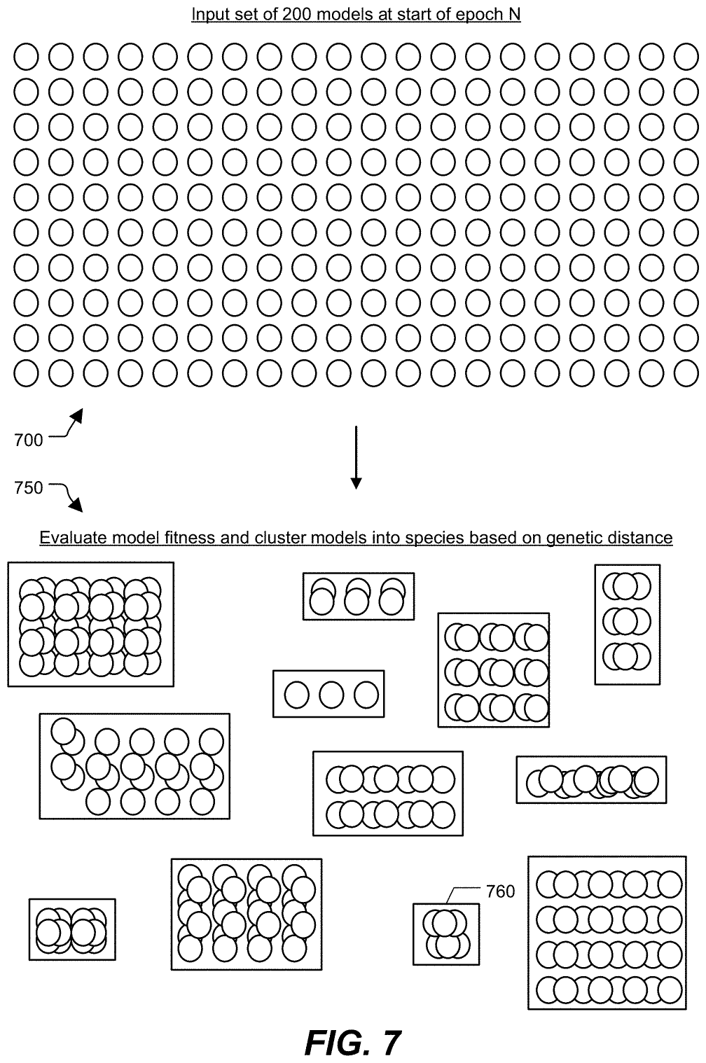

The model 600 may also include a species identifier (ID) 630 and fitness data 640. The species ID 630 may indicate which of a plurality of species the model 600 is classified in, as further described with reference to FIG. 7. The fitness data 640 may indicate how well the model 600 models the input data set 502. For example, the fitness data 640 may include a fitness value that is determined based on evaluating the fitness function 540 with respect to the model 600, as further described herein.

Returning to FIG. 5, the fitness function 540 may be an objective function that can be used to compare the models of the input set 520. In some examples, the fitness function 540 is based on a frequency and/or magnitude of errors produced by testing a model on the input data set 502. As a simple example, assume the input data set 502 includes ten rows, that the input data set 502 includes two columns denoted A and B, and that the models illustrated in FIG. 5 represent neural networks that output a predicted a value of B given an input value of A. In this example, testing a model may include inputting each of the ten values of A from the input data set 502, comparing the predicted values of B to the corresponding actual values of B from the input data set 502, and determining if and/or by how much the two predicted and actual values of B differ. To illustrate, if a particular neural network correctly predicted the value of B for nine of the ten rows, then the a relatively simple fitness function 540 may assign the corresponding model a fitness value of 4/10=0.9. It is to be understood that the previous example is for illustration only and is not to be considered limiting. In some aspects, the fitness function 540 may be based on factors unrelated to error frequency or error rate, such as number of input nodes, node layers, hidden layers, connections, computational complexity, etc.

In a particular aspect, fitness evaluation of models may be performed in parallel. To illustrate, the system 500 may include additional devices, processors, cores, and/or threads 590 to those that execute the genetic algorithm 510 and the backpropagation trainer 580. These additional devices, processors, cores, and/or threads 590 may test model fitness in parallel based on the input data set 502 and may provide the resulting fitness values to the genetic algorithm 510.

In a particular aspect, the genetic algorithm 510 may be configured to perform speciation. For example, the genetic algorithm 510 may be configured to cluster the models of the input set 520 into species based on “genetic distance” between the models. Because each model represents a neural network, the genetic distance between two models may be based on differences in nodes, activation functions, aggregation functions, connections, connection weights, etc. of the two models. In an illustrative example, the genetic algorithm 510 may be configured to serialize a model into a bit string. In this example, the genetic distance between models may be represented by the number of differing bits in the bit strings corresponding to the models. The bit strings corresponding to models may be referred to as “encodings” of the models. Speciation is further described with reference to FIG. 7.

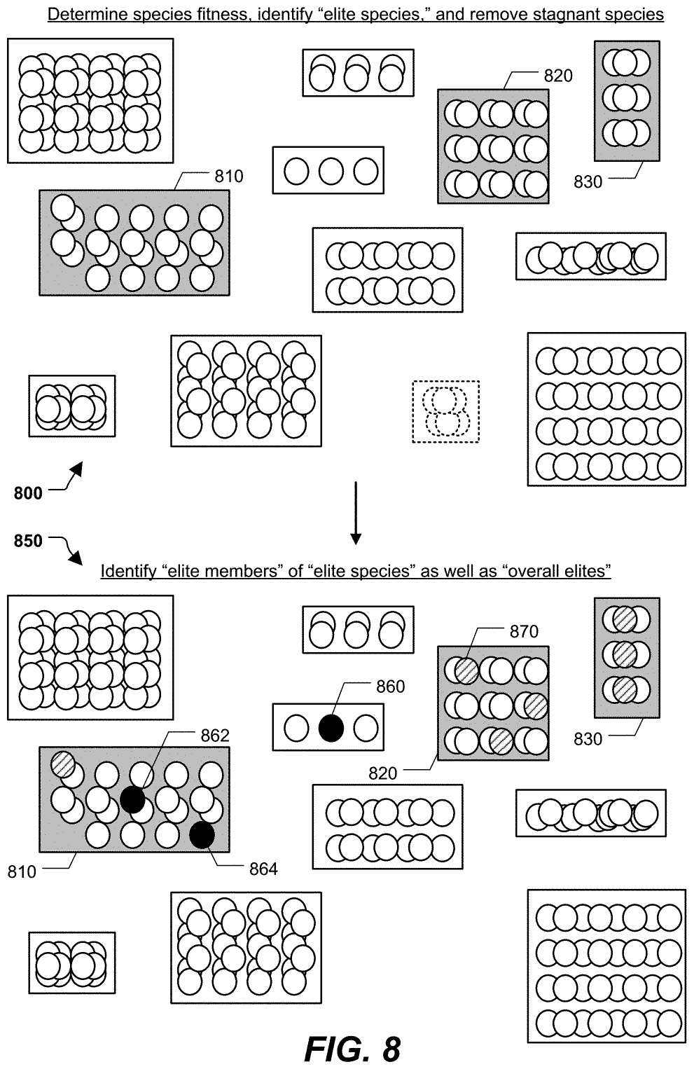

Because the genetic algorithm 510 is configured to mimic biological evolution and principles of natural selection, it may be possible for a species of models to become “extinct.” The stagnation criterion 550 may be used to determine when a species should become extinct, e.g., when the models in the species are to be removed from the genetic algorithm 510. Stagnation is further described with reference to FIG. 8.

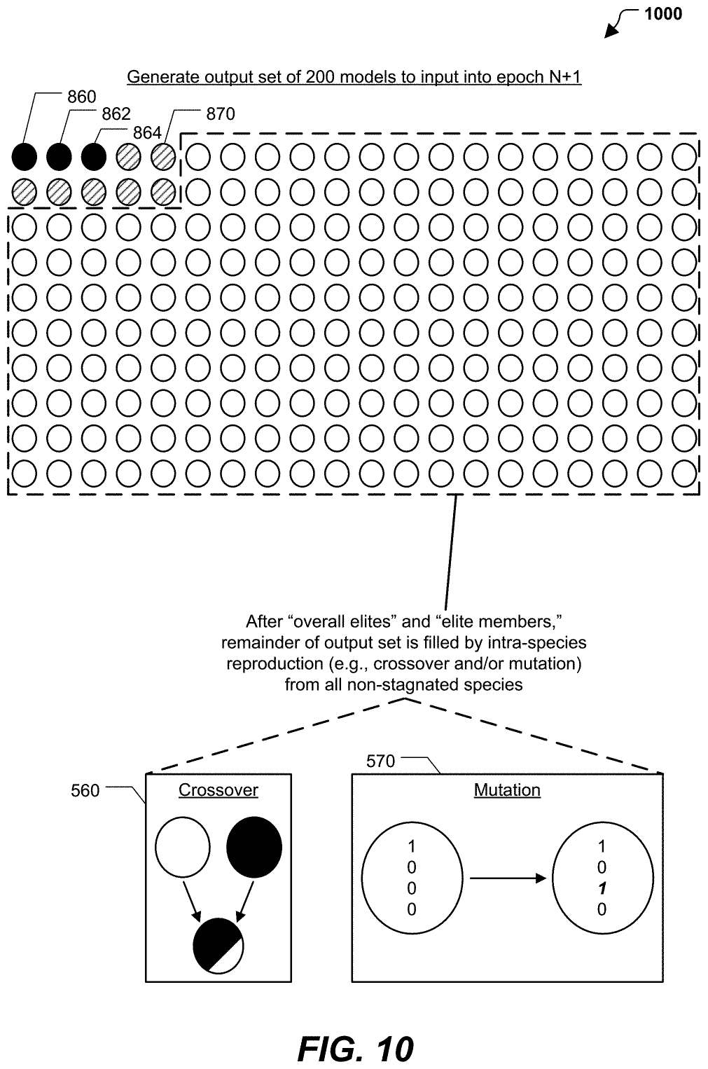

The crossover operation 560 and the mutation operation 570 is highly stochastic under certain constraints and a defined set of probabilities optimized for model building, which produces reproduction operations that can be used to generate the output set 530, or at least a portion thereof, from the input set 520. In a particular aspect, the genetic algorithm 510 utilizes intra-species reproduction but not inter-species reproduction in generating the output set 530. Including intra-species reproduction and excluding inter-species reproduction may be based on the assumption that because they share more genetic traits, the models of a species are more likely to cooperate and will therefore more quickly converge on a sufficiently accurate neural network. In some examples, inter-species reproduction may be used in addition to or instead of intra-species reproduction to generate the output set 530. Crossover and mutation are further described with reference to FIG. 10.

Left alone and given time to execute enough epochs, the genetic algorithm 510 may be capable of generating a model (and by extension, a neural network) that meets desired accuracy requirements. However, because genetic algorithms utilize randomized selection, it may be overly time-consuming for a genetic algorithm to arrive at an acceptable neural network. In accordance with the present disclosure, to “help” the genetic algorithm 510 arrive at a solution faster, a model may occasionally be sent from the genetic algorithm 510 to the backpropagation trainer 580 for training. This model is referred to herein as a trainable model 522. In particular, the trainable model 522 may be based on crossing over and/or mutating the fittest models of the input set 520, as further described with reference to FIG. 4. Thus, the trainable model 522 may not merely be a genetically “trained” file produced by the genetic algorithm 510. Rather, the trainable model 522 may represent an advancement with respect to the fittest models of the input set 520.

The backpropagation trainer 580 may utilize a portion, but not all of the input data set 502 to train the connection weights of the trainable model 522, thereby generating a trained model 582. For example, the portion of the input data set 502 may be input into the trainable model 522, which may in turn generate output data. The input data set 502 and the output data may be used to determine an error value, and the error value may be used to modify connection weights of the model, such as by using gradient descent or another function.

The backpropagation trainer 580 may train using a portion rather than all of the input data set 502 to mitigate overfit concerns and/or to shorten training time. The backpropagation trainer 580 may leave aspects of the trainable model 522 other than connection weights (e.g., neural network topology, activation functions, etc.) unchanged. Backpropagating a portion of the input data set 502 through the trainable model 522 may serve to positively reinforce “genetic traits” of the fittest models in the input set 520 that were used to generate the trainable model 522. Because the backpropagation trainer 580 may be executed on a different device, processor, core, and/or thread than the genetic algorithm 510, the genetic algorithm 510 may continue executing additional epoch(s) while the connection weights of the trainable model 522 are being trained. When training is complete, the trained model 582 may be input back into (a subsequent epoch of) the genetic algorithm 510, so that the positively reinforced “genetic traits” of the trained model 582 are available to be inherited by other models in the genetic algorithm 510.

Operation of the system 500 is now described with reference to FIGS. 7-11. It is to be understood, however, that in alternative implementations certain operations may be performed in a different order than described. Moreover, operations described as sequential may be instead be performed at least partially concurrently, and operations described as being performed at least partially concurrently may instead be performed sequentially.

During a configuration stage of operation, a user may specify data sources from which the pre-processor 504 is to determine the input data set 502. The user may also specify a particular data field or a set of data fields in the input data set 502 to be modeled. The pre-processor 504 may determine the input data set 502, determine a machine learning to generate likely scenarios that can be used in decision making, and initialize the AMB engine (e.g., the genetic algorithm 510 and/or the backpropagation trainer 580) based on the input data set 502 and the machine learning problem type. As an illustrative non-limiting example, the pre-processor 504 may determine that the data field(s) to be modeled corresponds to output nodes of a neural network that is to be generated by the system 500. For example, if a user indicates that the value of a particular data field is to be modeled (e.g., to predict the value based on other data of the data set), the model may be generated by the system 500 to include an output node that generates an output value corresponding to a modeled value of the particular data field. In particular implementations, the user can also configure other aspects of the model. For example, the user may provide input to indicate a particular data field of the data set that is to be included in the model or a particular data field of the data set that is to be omitted from the model. As another example, the user may provide input to constrain allowed model topologies. To illustrate, the model may be constrained to include no more than a specified number of input nodes, no more than a specified number of hidden layers, or no recurrent loops.

Further, in particular implementations, the user can configure aspects of the genetic algorithm 510, such as via input to the pre-processor 504 or graphical user interfaces (GUIs) generated by the pre-processor 504. For example, the user may provide input to limit a number of epochs that will be executed by the genetic algorithm 510. Alternatively, the user may specify a time limit indicating an amount of time that the genetic algorithm 510 has to generate the model, and the genetic algorithm 510 may determine a number of epochs that will be executed based on the specified time limit. To illustrate, an initial epoch of the genetic algorithm 510 may be timed (e.g., using a hardware or software timer at the computing device executing the genetic algorithm 510), and a total number of epochs that are to be executed within the specified time limit may be determined accordingly. As another example, the user may constrain a number of models evaluated in each epoch, for example by constraining the size of the input set 520 and/or the output set 530. As yet another example, the user can define a number of trainable models 522 to be trained by the backpropagation trainer 580 and fed back into the genetic algorithm 510 as trained models 582.

In particular aspects, configuration of the genetic algorithm 510 by the pre-processor 504 includes performing other pre-processing steps. For example, the pre-processor 504 may determine whether a neural network is to be generated for a regression problem, a classification problem, a reinforcement learning problem, etc. As another example, the input data set 502 may be “cleaned” to remove obvious errors, fill in data “blanks,” etc. in the data source(s) from which the input data set 502 is generated. As another example, values in the input data set 502 may be scaled (e.g., to values between 0 and 1) relative to values in the data source(s). As yet another example, non-numerical data (e.g., categorical classification data or Boolean data) in the data source(s) may be converted into numerical data or some other form of data that is compatible for ingestion and processing by a neural network. Thus, the pre-processor 504 may serve as a “front end” that enables the same AMB engine to be driven by input data sources for multiple types of computing problems, including but not limited to classification problems, regression problems, and reinforcement learning problems.

During automated model building, the genetic algorithm 510 may automatically generate an initial set of models based on the input data set 502, received user input indicating (or usable to determine) the type of problem to be solved, etc. (e.g., the initial set of models is data-driven). As illustrated in FIG. 6, each model may be specified by at least a neural network topology, an activation function, and link weights. The neural network topology may indicate an arrangement of nodes (e.g., neurons). For example, the neural network topology may indicate a number of input nodes, a number of hidden layers, a number of nodes per hidden layer, and a number of output nodes. The neural network topology may also indicate the interconnections (e.g., axons or links) between nodes.

The initial set of models may be input into an initial epoch of the genetic algorithm 510 as the input set 520, and at the end of the initial epoch, the output set 530 generated during the initial epoch may become the input set 520 of the next epoch of the genetic algorithm 510. In some examples, the input set 520 may have a specific number of models. For example, as shown in a first stage 700 of operation in FIG. 7, the input set may include 600 models. It is to be understood that alternative examples may include a different number of models in the input set 520 and/or the output set 530.

For the initial epoch of the genetic algorithm 510, the topologies of the models in the input set 520 may be randomly or pseudo-randomly generated within constraints specified by any previously input configuration settings. Accordingly, the input set 520 may include models with multiple distinct topologies. For example, a first model may have a first topology, including a first number of input nodes associated with a first set of data parameters, a first number of hidden layers including a first number and arrangement of hidden nodes, one or more output nodes, and a first set of interconnections between the nodes. In this example, a second model of epoch may have a second topology, including a second number of input nodes associated with a second set of data parameters, a second number of hidden layers including a second number and arrangement of hidden nodes, one or more output nodes, and a second set of interconnections between the nodes. Since the first model and the second model are both attempting to model the same data field(s), the first and second models have the same output nodes.

The genetic algorithm 510 may automatically assign an activation function, an aggregation function, a bias, connection weights, etc. to each model of the input set 520 for the initial epoch. In some aspects, the connection weights are assigned randomly or pseudo-randomly. In some implementations, a single activation function is used for each node of a particular model. For example, a sigmoid function may be used as the activation function of each node of the particular model. The single activation function may be selected based on configuration data. For example, the configuration data may indicate that a hyperbolic tangent activation function is to be used or that a sigmoid activation function is to be used. Alternatively, the activation function may be randomly or pseudo-randomly selected from a set of allowed activation functions, and different nodes of a model may have different types of activation functions. In other implementations, the activation function assigned to each node may be randomly or pseudo-randomly selected (from the set of allowed activation functions) for each node the particular model. Aggregation functions may similarly be randomly or pseudo-randomly assigned for the models in the input set 520 of the initial epoch. Thus, the models of the input set 520 of the initial epoch may have different topologies (which may include different input nodes corresponding to different input data fields if the data set includes many data fields) and different connection weights. Further, the models of the input set 520 of the initial epoch may include nodes having different activation functions, aggregation functions, and/or bias values/functions.

Continuing to a second stage 750 of operation, each model of the input set 520 may be tested based on the input data set 502 to determine model fitness. For example, the input data set 502 may be provided as input data to each model, which processes the input data set (according to the network topology, connection weights, activation function, etc., of the respective model) to generate output data. The output data of each model may be evaluated using the fitness function 540 to determine how well the model modeled the input data set 502. For example, in the case of a regression problem, the output data may be evaluated by comparing a prediction value in the output data to an actual value in the input data set 502. As another example, in the case of a classification problem, a classifier result indicated by the output data may be compared to a classification associated with the input data set 502 to determine if the classifier result matches the classification in the input data set 502. As yet another example, in the case of a reinforcement learning problem, a reward may be determined (e.g., calculated) based on evaluation of an environment, which may include one or more variables, functions, etc. In a reinforcement learning problem, the fitness function 540 may be the same as or may be based on the reward function(s). Fitness of a model may be evaluated based on performance (e.g., accuracy) of the model, complexity (or sparsity) of the model, or a combination thereof. As a simple example, in the case of a regression problem or reinforcement learning problem, a fitness value may be assigned to a particular model based on an error value associated with the output data of that model or based on the value of the reward function, respectively. As another example, in the case of a classification problem, the fitness value may be assigned based on whether a classification determined by a particular model is a correct classification, or how many correct or incorrect classifications were determined by the model.

In a more complex example, the fitness value may be assigned to a particular model based on both prediction/classification accuracy or reward optimization as well as complexity (or sparsity) of the model. As an illustrative example, a first model may model the data set well (e.g., may generate output data or an output classification with a relatively small error, or may generate a large positive reward function value) using five input nodes (corresponding to five input data fields), whereas a second potential model may also model the data set well using two input nodes (corresponding to two input data fields). In this illustrative example, the second model may be sparser (depending on the configuration of hidden nodes of each network model) and therefore may be assigned a higher fitness value that the first model.

As shown in FIG. 7, the second stage 750 may include clustering the models into species based on genetic distance. In a particular aspect, the species ID 630 of each of the models may be set to a value corresponding to the species that the model has been clustered into.

Continuing to FIG. 8, during a third stage 800 and a fourth stage 850 of operation, a species fitness may be determined for each of the species. The species fitness of a species may be a function of the fitness of one or more of the individual models in the species. As a simple illustrative example, the species fitness of a species may be the average of the fitness of the individual models in the species. As another example, the species fitness of a species may be equal to the fitness of the fittest or least fit individual model in the species. In alternative examples, other mathematical functions may be used to determine species fitness. The genetic algorithm 510 may maintain a data structure that tracks the fitness of each species across multiple epochs. Based on the species fitness, the genetic algorithm 510 may identify the “fittest” species, shaded and denoted in FIG. 8 as “elite species.” Although three elite species 810, 820, and 830 are shown in FIG. 8, it is to be understood that in alternate examples a different number of elite species may be identified.

In a particular aspect, the genetic algorithm 510 uses species fitness to determine if a species has become stagnant and is therefore to become extinct. As an illustrative non-limiting example, the stagnation criterion 550 may indicate that a species has become stagnant if the fitness of that species remains within a particular range (e.g., +/−6%) for a particular number (e.g., 6) epochs. If a species satisfies stagnation criteria, the species and all underlying models may be removed from the genetic algorithm 510. In the illustrated example, species 760 of FIG. 7 is removed, as shown in the third stage 800 through the use of broken lines.

Proceeding to the fourth stage 850, the fittest models of each “elite species” may be identified. The fittest models overall may also be identified. In the illustrated example, the three fittest models of each “elite species” are denoted “elite members” and shown using a hatch pattern. Thus, model 870 is an “elite member” of the “elite species” 820. The three fittest models overall are denoted “overall elites” and are shown using black circles. Thus, models 860, 862, and 864 are the “overall elites” in the illustrated example. As shown in FIG. 8 with respect to the model 860, an “overall elite” need not be an “elite member,” e.g., may come from a non-elite species. In an alternate implementation, a different number of “elite members” per species and/or a different number of “overall elites” may be identified.

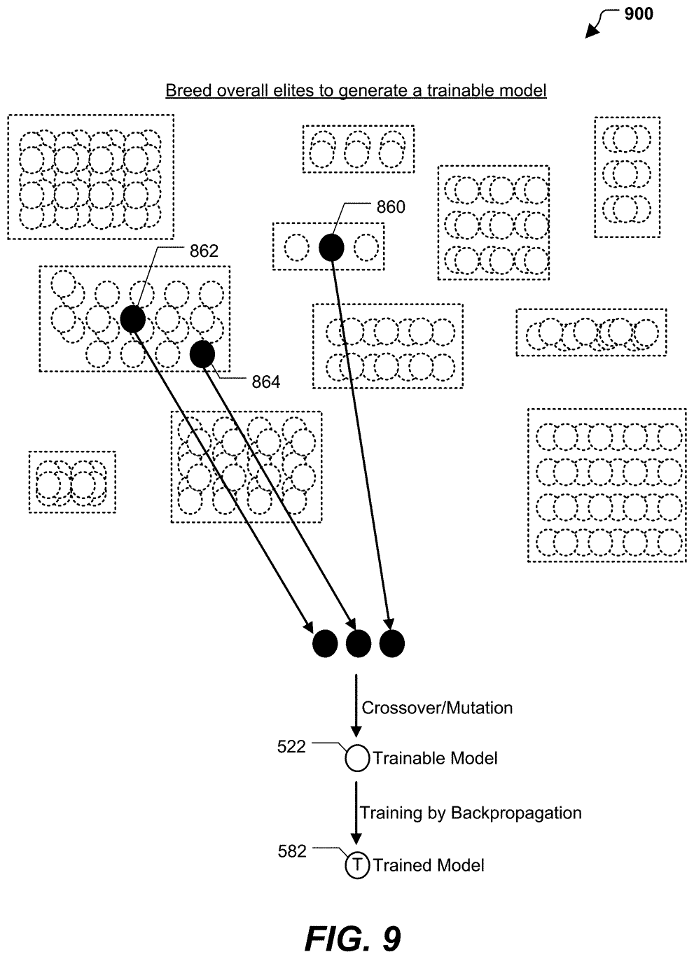

Referring now to FIG. 9, during a fifth stage 900 of operation, the “overall elite” models 860, 862, and 864 may be genetically combined to generate the trainable model 522. For example, genetically combining models may include crossover operations in which a portion of one model is added to a portion of another model, as further illustrated in FIG. 10. As another example, a random mutation may be performed on a portion of one or more of the “overall elite” models 860, 862, 864 and/or the trainable model 522. The trainable model 522 may be sent to the backpropagation trainer 580, as described with reference to FIG. 5. The backpropagation trainer 580 may train connection weights of the trainable model 522 based on a portion of the input data set 502. When training is complete, the resulting trained model 582 may be received from the backpropagation trainer 580 and may be input into a subsequent epoch of the genetic algorithm 510.

Continuing to FIG. 10, while the backpropagation trainer 580 trains the trainable model, the output set 530 of the epoch may be generated in a sixth stage 1000 of operation. In the illustrated example, the output set 530 includes the same number of models, e.g., 600 models, as the input set 520. The output set 530 may include each of the “overall elite” models 860-864. The output set 530 may also include each of the “elite member” models, including the model 870. Propagating the “overall elite” and “elite member” models to the next epoch may preserve the “genetic traits” resulted in caused such models being assigned high fitness values.

The rest of the output set 530 may be filled out by random intra-species reproduction using the crossover operation 560 and/or the mutation operation 570. In the illustrated example, the output set 530 includes 10 “overall elite” and “elite member” models, so the remaining (e.g., one hundred and ninety) models may be randomly generated based on intra-species reproduction using the crossover operation 560 and/or the mutation operation 570. After the output set 530 is generated, the output set 530 may be provided as the input set 520 for the next epoch of the genetic algorithm 510.

During the crossover operation 560, a portion of one model may be combined with a portion of another model, where the size of the respective portions may or may not be equal. To illustrate with reference to the model “encodings” described with respect to FIG. 5, the crossover operation 560 may include concatenating bits 0 to p of one bit string with bits p+1 to q of another bit string, where p and q are integers and p+q is equal to the total size of a bit string that represents a model resulting from the crossover operation 560. When decoded, the resulting bit string after the crossover operation 560 produces a neural network that differs from each of its “parent” neural networks in terms of topology, activation function, aggregation function, bias value/function, link weight, or any combination thereof.

Thus, the crossover operation 560 may be a random or pseudo-random biological operator that generates a model of the output set 530 by combining aspects of a first model of the input set 520 with aspects of one or more other models of the input set 520. For example, the crossover operation 560 may retain a topology of hidden nodes of a first model of the input set 520 but connect input nodes of a second model of the input set to the hidden nodes. As another example, the crossover operation 560 may retain the topology of the first model of the input set 520 but use one or more activation functions of the second model of the input set 520. In some aspects, rather than operating on models of the input set 520, the crossover operation 560 may be performed on a model (or models) generated by mutation of one or more models of the input set 520. For example, the mutation operation 570 may be performed on a first model of the input set 520 to generate an intermediate model and the crossover operation 560 may be performed to combine aspects of the intermediate model with aspects of a second model of the input set 520 to generate a model of the output set 530.

During the mutation operation 570, a portion of a model may be randomly modified. The frequency of mutations may be based on a mutation probability metric, which may be user-defined or randomly selected/adjusted. To illustrate with reference to the model “encodings” described with respect to FIG. 5, the mutation operation 570 may include randomly “flipping” one or more bits a bit string.

The mutation operation 570 may thus be a random or pseudo-random biological operator that generates or contributes to a model of the output set 530 by mutating any aspect of a model of the input set 520. For example, the mutation operation 570 may cause the topology a particular model of the input set to be modified by addition or omission of one or more input nodes, by addition or omission of one or more connections, by addition or omission of one or more hidden nodes, or a combination thereof. As another example, the mutation operation 570 may cause one or more activation functions, aggregation functions, bias values/functions, and/or or connection weights to be modified. In some aspects, rather than operating on a model of the input set, the mutation operation 570 may be performed on a model generated by the crossover operation 560. For example, the crossover operation 560 may combine aspects of two models of the input set 520 to generate an intermediate model and the mutation operation 570 may be performed on the intermediate model to generate a model of the output set 530.

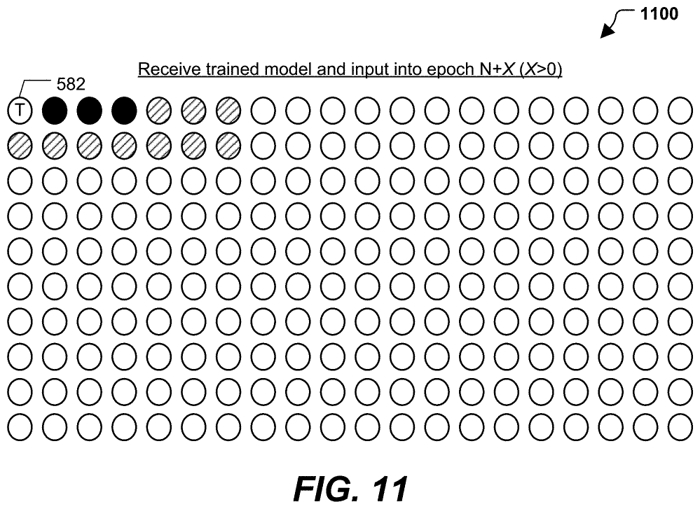

The genetic algorithm 510 may continue in the manner described above through multiple epochs. When the genetic algorithm 510 receives the trained model 582, the trained model 582 may be provided as part of the input set 520 of the next epoch, as shown in a seventh stage 1100 of FIG. 11. For example, the trained model 582 may replace one of the other 600 models in the input set 520 or may be a 201^{st} model of the input set (e.g., in some epochs, more than 600 models may be processed). During training by the backpropagation trainer 580, the genetic algorithm 510 may have advanced one or more epochs. Thus, when the trained model 582 is received, the trained model 582 may be inserted as input into an epoch subsequent to the epoch during which the corresponding trainable model 522 was provided to the backpropagation trainer 580. To illustrate, if the trainable model 522 was provided to the backpropagation trainer 580 during epoch N, then the trained model 582 may be input into epoch N+X, where X is an integer greater than zero.

In the example of FIGS. 5 and 11, a single trainable model 522 is provided to the backpropagation trainer 580 and a single trained model 582 is received from the backpropagation trainer 580. When the trained model 582 is received, the backpropagation trainer 580 becomes available to train another trainable model. Thus, because training takes more than one epoch, trained models 582 may be input into the genetic algorithm 510 sporadically rather than every epoch after the initial epoch. In some implementations, the backpropagation trainer 580 may have a queue or stack of trainable models 522 that are awaiting training. The genetic algorithm 510 may add trainable models 522 to the queue or stack as they are generated and the backpropagation trainer 580 may remove a training model 522 from the queue or stack at the start of a training cycle. In some implementations, the system 500 includes multiple backpropagation trainers 580 (e.g., executing on different devices, processors, cores, or threads). Each of the backpropagation trainers 580 may be configured to simultaneously train a different trainable model 522 to generate a different trained model 582. In such examples, more than one trainable model 522 may be generated during an epoch and/or more than one trained model 582 may be input into an epoch.

Operation at the system 500 may continue iteratively until specified a termination criterion, such as a time limit, a number of epochs, or a threshold fitness value (of an overall fittest model) is satisfied. When the termination criterion is satisfied, an overall fittest model of the last executed epoch may be selected and output as representing a neural network that best models the input data set 502. In some examples, the overall fittest model may undergo a final training operation (e.g., by the backpropagation trainer 580) before being output.

Although various aspects are described with reference to a backpropagation training, it is to be understood that in alternate implementations different types of training may also be used in the system 500. For example, models may be trained using a genetic algorithm training process. In this example, genetic operations similar to those described above are performed while all aspects of a model, except for the connection weight, are held constant.

Performing genetic operations may be less resource intensive than evaluating fitness of models and training of models using backpropagation. For example, both evaluating the fitness of a model and training a model include providing the input data set 502, or at least a portion thereof, to the model, calculating results of nodes and connections of a neural network to generate output data, and comparing the output data to the input data set 502 to determine the presence and/or magnitude of an error. In contrast, genetic operations do not operate on the input data set 502, but rather merely modify characteristics of one or more models. However, as described above, one iteration of the genetic algorithm 510 may include both genetic operations and evaluating the fitness of every model and species. Training trainable models generated by breeding the fittest models of an epoch may improve fitness of the trained models without requiring training of every model of an epoch. Further, the fitness of models of subsequent epochs may benefit from the improved fitness of the trained models due to genetic operations based on the trained models. Accordingly, training the fittest models enables generating a model with a particular error rate in fewer epochs than using genetic operations alone. As a result, fewer processing resources may be utilized in building highly accurate models based on a specified input data set 502.

The system 500 of FIG. 5 may thus support cooperative, data-driven execution of a genetic algorithm and a backpropagation trainer to automatically arrive at an output neural network model of an input data set. The system of FIG. 5 may arrive at the output neural network model faster than using a genetic algorithm or backpropagation alone and with reduced cost as compared to hiring a data scientist. In some cases, the neural network model output by the system 500 may also be more accurate than a model that would be generated by a genetic algorithm or backpropagation alone. The system 500 may also provide a problem-agnostic ability to generate neural networks. For example, the system 500 may represent a single automated model building framework that is capable of generating neural networks for at least regression problems, classification problems, and reinforcement learning problems. Further, the system 500 may enable generation of a generalized neural network that demonstrates improved adaptability to never-before-seen conditions. To illustrate, the neural network may mitigate or avoid overfitting to an input data set and instead may be more universal in nature. Thus, the neural networks generated by the system 500 may be capable of being deployed with fewer concerns about generating incorrect predictions.

Referring to FIGS. 12A, 12B, and 12C, a particular illustrative example of a system 1200 is shown. The system 1200, or portions thereof, may be implemented using (e.g., executed by) one or more computing devices, such as laptop computers, desktop computers, mobile devices, servers, and Internet of Things devices and other devices utilizing embedded processors and firmware or operating systems, etc. In the illustrated example, the system 1200 includes a first neural network 1210, second neural network(s) 1220, a third neural network 1270, and a loss function calculator and anomaly detector 1230 (hereinafter referred to as “calculator/detector”). As denoted in FIG. 12A and as further described herein, the first neural network 1210 may perform clustering, the second neural network(s) 1220 may include a variational autoencoder (VAE), and the third neural network 1270 may perform a latent space cluster mapping operation.

It is to be understood that operations described herein as being performed by the first neural network 1210, the second neural network(s) 1220, the third neural network 1270, or the calculator/detector 1230 may be performed by a device executing software configured to execute the calculator/detector 1230 and to train and/or evaluate the neural networks 1210, 1220, 1270. The neural networks 1210, 1220, 1270 may be represented as data structures stored in a memory, where the data structures specify nodes, links, node properties (e.g., activation function), and link properties (e.g., link weight). The neural networks 1210, 1220, 1270 may be trained and/or evaluated on the same or on different devices, processors (e.g., central processor unit (CPU), graphics processing unit (GPU) or other type of processor), processor cores, and/or threads (e.g., hardware or software thread). Moreover, execution of certain operations associated with the first neural network 1210, the second neural network(s) 1220, the third neural network 1270, or the calculator/detector 1230 may be parallelized.

The system 1200 may generally operate in two modes of operation: training mode and use mode. FIG. 12A corresponds to an example of the training mode and FIG. 12C corresponds to an example of the use mode.

Turning now to FIG. 12A, the first neural network 1210 may be trained, in an unsupervised fashion, to perform clustering. For example, the first neural network 1210 may receive first input data 1201. The first input data 1201 may be part of a larger data set and may include first features 1202, as shown in FIG. 12B. The first features 1202 may include continuous features (e.g., real numbers), categorical features (e.g., enumerated values, true/false values, etc.), and/or time-series data. In a particular aspect, enumerated values with more than two possibilities are converted into binary one-hot encoded data. To illustrate, if the possible values for a variable are “cat,” “dog,” or “sheep,” the variable is converted into a 3-bit value where 100 represents “cat,” 010 represents “dog,” and 001 represents “sheep.” In the illustrated example, the first features include n features having values A, B, C, . . . N, where n is an integer greater than zero.

The first neural network 1210 may include an input layer, an output layer, and zero or more hidden layers. The input layer of the first neural network 1210 may include n nodes, each of which receives one of the n first features 1202 as input. The output layer of the first neural network 1210 may include k nodes, where k is an integer greater than zero, and where each of the k nodes represents a unique cluster possibility. In a particular aspect, in response to the first input data 1201 being input to the first neural network 1210, the neural network 1210 generates first output data 1203 having k numerical values (one for each of the k output nodes), where each of the numerical values indicates a probability that the first input data 1201 is part of (e.g., classified in) a corresponding one of the k clusters, and where the sum of the numerical values is one. In the example of FIG. 12B, the k cluster probabilities in the first output data 1203 are denoted p₁ . . . pₖ, and the first output data 1203 indicates that the first input data 1201 is classified into cluster 2 with a probability of (p₂=0.91=91%).

A “pseudo-input” may be automatically generated and provided to the third neural network 1270. In the example of FIG. 12A, such pseudo-input is denoted as third input data 1292. As shown in FIG. 12B, the third input data 1292 may correspond to one-hot encoding for each of the k clusters. Thus, the third neural network 1270 may receive an identification of cluster(s) as input. The third neural network 1270 may map the cluster(s) into region(s) of a latent feature space. For example, the third neural network 1270 may output values μₚ and Σₚ, as shown at 1272, where μₚ and Σₚ represent mean and variance of a distribution (e.g., a Gaussian normal distribution), respectively, and the subscript “p” is used to denote that the values will be used as priors for cluster distance measurement, as further described below. μₚ and Σₚ may be vectors having mean and variance values for each latent space feature, as further explained below. By outputting different values of μₚ and Σₚ for different input cluster identifications, the third neural network 1270 may “place” clusters into different parts of latent feature space, where each of those individual clusters follows a distribution (e.g., a Gaussian normal distribution).

In a particular aspect, the second neural network(s) 1220 include a variational autoencoder (VAE). The second neural network(s) 1220 may receive second input data 1204 as input. In a particular aspect, the second input data 1204 is generated by a data augmentation process 1280 based on a combination of the first input data 1201 and the third input data 1292. For example, the second input data 1204 may include the n first features 1202 and may include k second features 1205, where the k second features 1205 are based on the third input data 1292, as shown in FIG. 12B. In the illustrated embodiment, the second features 1205 correspond to one-hot encodings for each of the k clusters. That is, the second input data 1204 has k entries, denoted 1204₁-1204ₖ in FIG. 12B. Each of the entries 1204₁-1204ₖ includes the same first features 1202. For the first entry 1204₁, the second features 1205 are “10 . . . 0” (i.e., a one-hot encoding for cluster 1). For the second entry 1204₂, the second features 1205 are “01 . . . 0” (i.e., a one-hot encoding for cluster 2). For the kth entry 1204ₖ, the second features 1205 are “00 . . . 1” (i.e., a one-hot encoding cluster k). Thus, the first input data 1201 is used to generate k entries in the second input data 1204.

The second neural network(s) 1220 generates second output data 1206 based on the second input data 1204. In a particular aspect, the second output data 1206 includes k entries 1206₁-1206ₖ, each of which is generated based on the corresponding entry 1204₁₋₁₂₀₄ₖ of the second input data 1204. Each entry of the second output data 1206 may include at least third features 1207 and variance values 1208 for the third features 1207. Although not shown in FIG. 1, the VAE may also generate k entries of μₑ and Σₑ, which may be used to construct the actual encoding space (often denoted as “z”). As further described below, the μₑ and Σₑ values may be compared to μₚ and Σₚ output from the third neural network 1270 during loss function calculation and anomaly detection. Each of the third features is a VAE “reconstruction” of a corresponding one of the first features 1202. In the illustrated embodiment, the reconstructions of features A . . . N are represented as A′ . . . N′ having associated variance values σ²₁ . . . σ²ₙ.

Referring to FIG. 12, the second neural network(s) 1220 may include an encoder network 1310 and a decoder network 1320. The encoder network 1310 may include an input layer 1301 including an input node for each of the n first features 1202 and an input node for each of the k second features 1205. The encoder network 1310 may also include one or more hidden layers 1302 that have progressively fewer nodes. A “latent” layer 1303 serves as an output layer of the encoder network 1310 and an input layer of the decoder network 1320. The latent layer 1303 corresponds to a dimensionally reduced latent space. The latent space is said to be “dimensionally reduced” because there are fewer nodes in the latent layer 1303 than there are in the input layer 1301. The input layer 1301 includes (n+k) nodes, and in some aspects the latent layer 1303 includes no more than half as many nodes, i.e., no more than (n+k)/2 nodes. By constraining the latent layer 1303 to fewer nodes than the input layer, the encoder network 1310 is forced to represent input data (e.g., the second input data 1204) in “compressed” fashion. Thus, the encoder network 1310 is configured to encode data from a feature space to the dimensionally reduced latent space. In a particular aspect, the encoder network 1310 generates values μₑ, Σₑ, which are data vectors having mean and variance values for each of the latent space features. The resulting distribution is sampled to generate the values (denoted “z”) in the “latent” layer 1303. The “e” subscript is used here to indicate that the values are generated by the encoder network 1310 of the VAE. The latent layer 1303 may therefore represent cluster identification and latent space location along with the input features in a “compressed” fashion. Because each of the clusters has its own Gaussian distribution, the VAE may considered a Gaussian Mixture Model (GMM) VAE.

The decoder network 1320 may approximately reverse the process performed by the encoder network 1310 with respect to the n features. Thus, the decoder network 1320 may include one or more hidden layers 1304 and an output layer 1305. The output layer 1305 outputs a reconstruction of each of the n input features and a variance (σ²) value for each of the reconstructed features. Therefore, the output layer 1305 includes n+n=2n nodes.

Returning to FIG. 12A, the calculator/detector 1230 calculates a loss (e.g., calculate the value of a loss function) for each entry 1206₁-1206ₖ of the second output data 1206, and calculates an aggregate loss based on the per-entry losses. Different loss functions may be used depending on the type of data that is present in the first features 1202.

In a particular aspect, the reconstruction loss function L_{R_confeature} for a continuous feature is represented by Gaussian loss in accordance with Equation 1:

$${L}_{R \_ confeature} = ln ( \frac{1}{\sqrt{2 {πσ}^{2}}} {e}^{- \frac{{( {x}^{′} - x )}^{2}}{2 {σ}^{2}}} ) , \qquad Equation 1$$

where ln is the natural logarithm function, σ² is variance, x′ is output/reconstruction value, and x is input value.

To illustrate, if the feature A of FIG. 12B, which corresponds to reconstruction output A′ and variance σ²₁, is a continuous feature, then its reconstruction loss function L_{R}(A) is shown by Equation 2:

$${L}_{R \_ confeature} ( A ) = ln ( \frac{1}{\sqrt{2 {πσ}_{1}^{2}}} {e}^{- \frac{{( {A}^{′} - A )}^{2}}{2 {σ}_{1}^{2}}} ) . \qquad Equation 2$$

In a particular aspect, the reconstruction loss function L_{R_catfeature} for a binary categorical feature is represented by binomial loss in accordance with Equation 3:

L_{R_catfeature}=xₜᵣᵤₑ ln x′+(1−xₜᵣᵤₑ)ln(1−x′) Equation 3,

where ln is the natural logarithm function, xₜᵣᵤₑ is one if the value of the feature is true, xₜᵣᵤₑ is zero if the value of the feature is false, and x′ is the output/reconstruction value (which will be a number between zero and one). It will be appreciated that Equation 3 corresponds to the natural logarithm of the Bernoulli probability of x′ given xₜᵣᵤₑ, which can also be written as ln P(x′|xₜᵣᵤₑ).

As an example, if the feature N of FIG. 12B, which corresponds to reconstruction output N′, is a categorical feature, then its loss function L_{R}(N) is shown by Equation 4 (variances may not be computed for categorical features because they are distributed by a binomial distribution rather than a Gaussian distribution):

L_{R_catfeature}(N)=Nₜᵣᵤₑ ln N′+(1−Nₜᵣᵤₑ)ln(1−N′) Equation 4.

The total reconstruction loss L_{R} for an entry may be a sum of each of the per-feature losses determined based on Equation 1 for continuous features and based on Equation 3 for categorical features:

L_{R}=ΣL_{R_catfeature}+ΣL_{R_catfeature} Equation 5

It is noted that Equations 1-5 deal with reconstruction loss. However, as combined clustering and anomaly detection are performed, loss function determination for an entry should also consider distance from clusters. In a particular aspect, cluster distance is incorporated into loss calculation using two Kullback-Leibler (KL) divergences.

The first KL divergence, KL₁, is represented by Equation 6 below and represents the deviation of μ_{P}, Σ_{P} from μₑ, Σₑ:

KL₁=KL(μₑ,Σₑ∥μₚ,Σₚ) Equation 6,

where μₑ, Σₑ are the clustering parameters generated at the VAE (i.e., the second neural network(s) 1220) and μₚ, Σₚ are the values shown at 1272 being output by the latent space cluster mapping network (i.e., the third neural network 1270).

The second KL divergence, KL₂, is based on the deviation of a uniform distribution from the cluster probabilities being output by the latent space cluster mapping network (i.e., the third neural network 1270). KL₂ is represented by Equation 7 below:

KL₂=KL(P∥P_{Uniform}) Equation 7,

where P is the cluster probability vector represented by the first output data 1203.

The calculator/detector 1230 may determine an aggregate loss L for each training sample (e.g., the first input data 1201) in accordance with Equation 8 below:

$$L = {KL}_{2} + {\sum }_{k} p ( k ) ( {L}_{R} ( k ) + {KL}_{1} ( k ) ) \qquad Equation 8$$

where KL₂ is from Equation 7, p(k) are the cluster probabilities in the first output data 1203 (which are used as weighting factors), L_{R} is from Equation 5, and KL₁ is from Equation 6. It will be appreciated that the aggregate loss L of Equation 8 is a single quantity that is based on both reconstruction loss as well as cluster distance, where the reconstruction loss function differs for different types of data.

The calculator/detector 1230 may initiate adjustment at one or more of the first neural network 1210, the second neural network(s) 1220, or the third neural network 1270, based on the aggregate loss L. For example, link weights, bias functions, bias values, etc. may be modified via backpropagation to minimize the aggregate loss L using stochastic gradient descent. In some aspects, the amount of adjustment performed during each iteration of backpropagation is based on learning rate. In one example, the learning rate, lr, is initially based on the following heuristic:

$$lr = {10}^{- 4} \frac{{N}_{data}}{{N}_{params}} , \qquad Equation 9$$

where N_{data} is the number of features and Nₚₐᵣₐₘₛ is the number of parameters being adjusted in the system (e.g., link weights, bias functions, bias values, etc. across the neural networks 1210, 1220, 1270). In some examples, the learning rate, lr, is determined based on Equation 8 but is subjected to floor and ceiling functions so that lr is always between 5×10⁻⁶ and 10⁻³.

The calculator/detector 1230 may also be configured to output anomaly likelihood 1260, as shown in FIG. 12C, which may be output in addition to a cluster identifier (ID) 1250 that is based on the first output data 1203 generated by the first neural network 1210. For example, the cluster ID 1250 is an identifier of the cluster having the highest value in the first output data 1203. Thus, in the illustrated, example, the cluster ID 1250 for the first input data 1201 is an identifier of cluster 2. The anomaly likelihood 1260 may indicate the likelihood that the first input data 1201 corresponds to an anomaly. For example, the anomaly likelihood may be based on how well the second neural network(s) 1220 (e.g., the VAE) reconstruct the input data and how similar μₑ, Σₑ are to μₚ, Σₚ. The cluster ID 1250 and the anomaly likelihood 1260 are further described below.

As described above, the system 1200 may generally operate in two modes of operation: training mode and use mode. During operation in the training mode (FIG. 12A), training data is provided to the neural networks 1210, 1220, 1270 to calculate loss and adjust the parameters of the neural networks 1210, 1220, 1270. For example, input data may be separated into a training set (e.g., 90% of the data) and a testing set (e.g., 10% of the data). The training set may be passed through the system 1200 during a training epoch. The trained system may then be run against the testing set to determine an average loss in the testing set. This process may then be repeated for additional epochs. If the average loss in the testing set starts exhibiting an upward trend, the learning rate (lr) may be decreased. If the average loss in the testing set no longer decreases for a threshold number of epochs (e.g., ten epochs), the training mode may conclude.

After training is completed, the system 1200 enters use mode (alternatively referred to as “evaluation mode”) (FIG. 12C). While operating in the use mode, the system 1200 generates cluster identifiers 1250 and anomaly likelihoods 1260 for non-training data, such as real-time or near-real-time data that is empirically measured. In FIG. 12C, identification of certain intermediate data structures is omitted for clarity. When a new data sample is received, the system 1200 outputs a cluster ID 1250 for the new data sample. The cluster ID 1250 may be based on a highest value within the cluster probabilities output in the first output data 1203 by the first neural network 1210. The system 1200 also outputs an anomaly likelihood 1260 for the new data sample. The anomaly likelihood 1260 (alternatively referred to as an “AnomalyScore”) may be determined based on Equation 10:

AnomalyScore=L_{R}(i)×N(μₑ|μₚ,Σₚ) Equation 10,

where i is the cluster identified by the cluster ID 1250, L_{R}(i) is the reconstruction loss for the ith entry of the second input data (which includes the one-hot encoding for cluster i), and the second term corresponds to the Gaussian probability of μₑ given μₚand Σₚ. The anomaly likelihood 1260 indicates the likelihood that the first input data 1201 corresponds to an anomaly. The anomaly likelihood 1260 increases in value with reconstruction loss and when the most likely cluster for the new data sample is far away from where the new data sample was expected to be mapped.

The system 1200 of FIGS. 12A-12C may thus be trained and then used to concurrently perform both clustering and anomaly detection. Training and using the system 1200 may be preferable from a cost and resource-consumption standpoint as compared to using different machine learning models for clustering than for anomaly detection, where the models are trained using different techniques on different training data.

Moreover, it will be appreciated the system 1200 may be applied in various technological settings. As a first illustrative non-limiting example, each of multiple machines, industrial equipment, turbines, engines, etc. may have one or more sensors. The sensors may be on-board or may be coupled to or otherwise associated with the machines. Each sensor may provide periodic empirical measurements to a network server. Measurements may include temperature, vibration, sound, movement in one or more dimensions, movement along one or more axes of rotation, etc. When a new data sample (e.g., readings from multiple sensors) is received, the new data sample may be passed through the clustering and anomaly detection system. The cluster ID 1250 for the data sample may correspond to a state of operation of the machine. Some cluster IDs often lead to failure and do not otherwise occur, and such cluster IDs may be used as failure prognosticators. The anomaly likelihood 1260 may also be used as a failure prognosticator. The cluster ID 1250 and/or the anomaly likelihood 1260 may be used to trigger operational alarms, notifications to personnel (e.g., e-mail, text message, telephone call, etc.), automatic parts shutdown (and initiation of fault-tolerance or redundancy measures), repair scheduling, etc.

As another example, the system 1200 may be used to monitor for rare anomalous occurrences in situations where “normal” operations or behaviors can fall into different categories. To illustrate, the system 1200 may be used to monitor for credit card fraud based on real-time or near-real-time observation of credit card transactions. In this example, clusters may represent different types of credit users. For example, a first cluster may represent people who generally use their credit cards a lot and place a large amount of money on the credit card each month, a second cluster may represent people who only use their credit card when they are out of cash, a third cluster may represent people who use their credit card very rarely, a fourth cluster may represent travelers who use their credit card a lot and in various cities/states/countries, etc. In this example, the cluster ID 1250 and the anomaly likelihood 1260 may be used to trigger account freezes, automated communication to the credit card holder, notifications to credit card/bank personnel, etc. By automatically determining such trained clusters during unsupervised learning (each of which can have its own Gaussian distribution), the combined clustering/anomaly detection system described herein may generate fewer false positives and fewer false negatives then a conventional VAE (which would assume all credit card users should be on a single Gaussian distribution).

In some examples, the system 1200 may include a driving feature detector (not shown) that is configured to compare the feature distribution within a particular cluster to the feature distributions of other clusters and of the input data set as a whole. By doing so, the driving feature detector may identify features that most “drive” the classification of a data sample into the particular cluster. Automated alarms/operations may additionally or alternatively be set up based on examining such driving features, which in some cases may lead to faster notification of a possible anomaly than with the system 1200 of FIGS. 12A-12C alone.

In particular aspects, topologies of the neural networks 1210, 1220, 1270 may be determined prior to training the neural networks 1210, 1220, 1270. In a first example, a neural network topology is determined based on performing principal component analysis (PCA) on an input data set. To illustrate, the PCA may indicate that although the input data set includes X features, the data can be represented with sufficient reconstructability using Y features, where X and Y are integers and Y is generally less than or equal to X/2. It will be appreciated that in this example, Y may be the number of nodes present in the latent layer 1303. After determining Y, the number of hidden layers 1302, 1304 and the number of nodes in the hidden layers 1302, 1304 may be determined. For example, each of the hidden layers may progressively halve the number of nodes from X to Y.

As another example, the topology of a neural network may be determined heuristically, such as based on an upper bound. For example, the topology of the first neural network 1210 may be determined by setting the value of k to an arbitrarily high number (e.g., 20, 50, 100, 500, or some other value). This value corresponds to the number of nodes in the output layer of the first neural network 1210, and the number of nodes in the input layer of the first neural network 1210 may be set to be the n, i.e., the number of first features 1202 (though in a different example, the number of input nodes may be less than n and may be determined using a feature selection heuristic/algorithm). Once the number of input and output nodes are determined for the first neural network 1210, the number of hidden layers and number of nodes in each hidden layer may be determined (e.g., heuristically).

As yet another example, a combination of PCA and hierarchical density-based spatial clustering of applications with noise (HDBSCAN) may be used to determine neural network topologies. As an illustrative non-limiting example, the input feature set may include one hundred features (i.e., n=100) and performing the PCA results in a determination that a subset of fifteen specific features (i.e., p=15) is sufficient to represent the data while maintaining at least a threshold variance (e.g., 90%). Running a HDBSCAN algorithm on the fifteen principal components results in a determination that there are eight clusters in the PCA data set. The number of clusters identified by the HDBSCAN algorithm may be adjusted by a programmable constant, such as +2, to determine a value of k. In this example, k=8+2=10. The number of input features (n=100), the number of clusters from HDBSCAN (k=10) and the number of principal components (p=15) may be used to determine neural network topologies (below, a hidden layer is assumed to have twice as many nodes as the layer it outputs to).

TABLE 1

| | |
|---|---|
| VAE | Input Layer = n input features + k clusters |
| | (one-hot encoding) = 1210 nodes |
| | Encoder Hidden Layer 2 = 60 nodes |
| | Encoder Hidden Layer 1 = 30 nodes |
| | Latent Layer = p principal components = 15 nodes |
| | each for μₑ and Σₑ |
| | Decoder Hidden Layer 1 = 30 nodes |
| | Decoder Hidden Layer 2 = 60 nodes |
| | Output Layer = n reconstructed features + n variance |
| | values = 200 nodes |

TABLE 2

| | |
|---|---|
| Clustering | Input Layer = n input features = 100 nodes |
| Network | Hidden Layer 1 = 60 nodes |
| | Hidden Layer 2 = 30 nodes |
| | Output Layer = k possible clusters = 10 nodes |

TABLE 3

| | |
|---|---|
| Latent Space | Input Layer = k possible clusters = 10 nodes |
| Cluster Mapping | Output Layer = p values for μₚ + p values |
| Network | for Σₚ = 30 nodes |

In a particular example, the hidden layer topology of the clustering network and the encoder network of the VAE may be the same. To illustrate, the VAE may have the topology shown in Table 1 above and the clustering network may have the topology shown in Table 4 below.

TABLE 4

| | |
|---|---|
| Clustering | Input Layer = n input features = 100 nodes |
| Network | Hidden Layer 2 = 60 nodes |
| | Hidden Layer 1 = 30 nodes |
| | Output Layer = k possible clusters = 10 nodes |

It is to be understood that the division and ordering of steps of various methods described herein is for illustrative purposes only and is not be considered limiting. In alternative implementations, certain steps or certain of the methods may be combined and other steps or methods may be subdivided into multiple steps or methods. Moreover, the ordering of steps within a method may change.

The systems and methods illustrated herein may be described in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, AWK, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of techniques for data transmission, signaling, data processing, network control, and the like.

The systems and methods of the present disclosure may take the form of or include a computer program product on a computer-readable storage medium or device having computer-readable program code (e.g., instructions) embodied or stored in the storage medium or device. Any suitable computer-readable storage medium or device may be utilized, including hard disks, CD-ROM, optical storage devices, magnetic storage devices, and/or other storage media. As used herein, a “computer-readable storage medium” or “computer-readable storage device” is not a signal.

Systems and methods may be described herein with reference to block diagrams and flowchart illustrations of methods, apparatuses (e.g., systems), and computer media according to various aspects. It will be understood that each functional block of a block diagrams and flowchart illustration, and combinations of functional blocks in block diagrams and flowchart illustrations, respectively, can be implemented by computer program instructions.

Computer program instructions may be loaded onto a computer or other programmable data processing apparatus to produce a machine, such that the instructions that execute on the computer or other programmable data processing apparatus create means for implementing the functions specified in the flowchart block or blocks. These computer program instructions may also be stored in a computer-readable memory or device that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

Although the disclosure may include a method, it is contemplated that it may be embodied as computer program instructions on a tangible computer-readable medium, such as a magnetic or optical memory or a magnetic or optical disk/disc. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

Changes and modifications may be made to the disclosed embodiments without departing from the scope of the present disclosure. These and other changes or modifications are intended to be included within the scope of the present disclosure, as expressed in the following claims.

What is claimed is:

1. A method comprising:
receiving, at a computing device from a first user device associated with a first user, first information identifying a start location of a trip, a start time of the trip, and an end location of the trip;
receiving at the computing device, second information indicating that a second user is to join the first user during at least a portion of the trip; and
responsive to output that is generated by at least one trained model based on inputting at least one of the first information or the second information into the at least one trained model, scheduling the trip to include travel of the first user from the start location to the end location and travel of the second user during at least the portion of the trip.

2. The method of claim 1, wherein scheduling the trip comprises sending a message to a road transport provider to initiate reservation of road transport for at least one of the first user or the second user.

3. The method of claim 1, wherein scheduling the trip comprises sending a message to a water transport provider to initiate reservation of water transport for at least one of the first user or the second user.

4. The method of claim 1, wherein scheduling the trip comprises sending a message to an aerial transport provider to initiate reservation of aerial transport for at least one of the first user or the second user.

5. The method of claim 1, further comprising sending a first message to the first user device to cause presentation of a first confirmation at the first user device, and sending a second message to a second user device to cause presentation of a second confirmation at the second user device.

6. The method of claim 1, wherein scheduling the trip comprises selecting a first mode of transport instead of a second mode of transport based at least part on the output generated by the at least one trained model.

7. The method of claim 6, wherein the first mode of transport is selected instead of the second mode of transport based at least in part on receiving information indicating congested travel conditions associated with the second mode of transport.

8. The method of claim 6, wherein the first mode of transport is selected instead of the second mode of transport based at least in part on pricing differences between the first mode of transport and the second mode of transport.

9. The method of claim 1, wherein the first information indicates a globally unique identifier (GUID) associated with the first user.

10. The method of claim 1, further comprising posting information regarding the scheduled trip to a decentralized ledger.

11. The method of claim 10, wherein the decentralized ledger comprises a public blockchain or a private hyperledger.

12. A computer-readable storage device storing instructions that, when executed, cause at least one processor to:
receive, from a first user device associated with a first user, first information identifying a start location of a trip, a start time of the trip, and an end location of the trip;
receive second information indicating that a second user is to join the first user during at least a portion of the trip; and
responsive to output that is generated by at least one trained model based on inputting at least one of the first information or the second information into the at least one trained model, schedule the trip to include travel of the first user from the start location to the end location and travel of the second user during at least the portion of the trip.

13. The computer-readable storage device of claim 12, wherein the instructions, when executed, further cause the at least one processor to send a message to a road transport provider to initiate reservation of road transport for at least one of the first user or the second user.

14. The computer-readable storage device of claim 12, wherein the instructions, when executed, further cause the at least one processor to send a message to a water transport provider to initiate reservation of water transport for at least one of the first user or the second user.

15. The computer-readable storage device of claim 12, wherein the instructions, when executed, further cause the at least one processor to send a message to an aerial transport provider to initiate reservation of aerial transport for at least one of the first user or the second user.

16. The computer-readable storage device of claim 12, wherein the instructions, when executed, further cause the at least one processor to send a first message to the first user device to cause presentation of a first confirmation at the first user device, and send a second message to a second user device to cause presentation of a second confirmation at the second user device.

17. The computer-readable storage device of claim 12, wherein the instructions, when executed, further cause the at least one processor to select a first mode of transport instead of a second mode of transport based at least part on the output generated by the at least one trained model.

18. The computer-readable storage device of claim 17, wherein the first mode of transport is selected instead of the second mode of transport based at least in part on:
information indicating congested travel conditions associated with the second mode of transport,
pricing differences between the first mode of transport and the second mode of transport, or
a combination thereof.

19. A vehicle key device comprising:
a plurality of hardware buttons to control one or more aspects of a vehicle;
an output port to output media content;
a battery;
a charging port to supply electrical charge to the battery; and
a display device to display information associated with at least one of a user or the vehicle.

20. The vehicle key device of claim 19, further comprising a network interface configured to communicate preference information to at least one of the vehicle, a public transport vehicle, or a network-accessible server.
